(19) United States
(12) Patent Application Publication
(10) Pub. No.: US 2012/0292254 A1
(43) Pub. Date: Nov. 22, 2012

(54) Treatment Apparatus and Methods

(76) Inventors: Jason Swearingen, New Albany, IN (US); Lindsay Swearingen, New Albany, IN (US)

(21) Appl. No.: 13/472,432

(22) Filed: May 15, 2012

Related U.S. Application Data
(60) Provisional application No. 61/486,458, filed on May 16, 2011.
(60) Provisional application No. 61/584,558, filed on Jan. 9, 2012.
(60) Provisional application No. 61/619,730, filed on Apr. 3, 2012.

(51) Int. Cl. C02F 1/66; C02F 1/62

(52) U.S. Cl. 210/638; 210/749; 210/702; 210/746

(57) ABSTRACT

Various methods and apparatus are disclosed that relate to one or more aspects of a treatment system that circum-neutralizes the pH of an aqueous stream, removes one or more heavy metals from the aqueous stream, circum-neutralizes the pH of a CCR supply, and/or removes one or more heavy metals from the CCR supply.

### CROSS-REFERENCE TO RELATED DOCUMENTS

This application claims the benefit of U.S. Provisional Application Ser. No. 61/486,458, filed May 16, 2011, U.S. Provisional Application Ser. No. 61/584,558, filed Jan. 9, 2012, and U.S. Provisional Application Ser. No. 61/619,730, filed Apr. 3, 2012, which are hereby incorporated by reference in their entirety. This application is also related to the following co-pending Applications: U.S. application Ser. No. 13/______, filed May 15, 2012; U.S. application Ser. No. 13/______, filed May 15, 2012; International Application No. PCT/US2012/______, filed May 15, 2012; and International Application No. PCT/US2012/______, filed May 15, 2012.

### TECHNICAL FIELD

The present invention is directed generally to one or more aspects of a treatment system. More particularly, various inventive methods and apparatus disclosed herein relate to one or more aspects of a treatment system such as a treatment system that neutralizes and/or remediates a stream and/or a treatment system that neutralizes and/or remediates coal combustion residue.

### BACKGROUND

Known systems and methods for treating an aqueous waste stream include utilizing one or more neutralizing compounds to neutralize the pH of the waste stream and then discharging the neutralized stream to a receptor (e.g., sewer, impoundment, river, lake, ocean). Although such methods allow for the neutralization of an acidic or alkaline waste stream, they may suffer from one or more disadvantages. For example, a relatively large quantity of neutralizing compound(s) (e.g., lime, sodium hydroxide, anhydrous ammonia) may be needed frequently in order to neutralize a fairly large aqueous waste stream. Moreover, such methods produce significant quantities of one or more by-products on a scale similar to the amount of neutralizing compound that is utilized. The costs associated with acquiring and handling such large quantities of neutralizing compounds and/or the costs associated with handling the concomitant byproducts present disadvantages to such methods. Also, for example, one or more heavy metals may be present in the neutralized stream at a quantity that may exceed regulatory limits, thus preventing discharge of the neutralized stream into a receptor (e.g., sewer, impoundment, river, lake, ocean).

Known systems and methods for treating a waste stream also include discharging an untreated waste stream directly into one or more onsite coal combustion residue (CCR) sedimentation ponds. Although such historical methods allow for the neutralization of an acidic or alkaline waste stream, they may suffer from one or more disadvantages. For example, the waste stream flows over the settled ash sediment allowing minimal mixing with the settled CCR sediment and minimal CCR surface area contact. This may lead to inefficient and/or incomplete neutralization of the waste stream. Also, for example, heavy metals that may be present in the waste stream and/or CCR sediment may become more mobile (e.g., transitioning of heavy metals from precipitated to dissolved state) due to pH level fluctuations (localized and/or widespread) within the sedimentation pond—potentially resulting in harmful environmental impact (e.g., groundwater contamination).

Thus, the applicants have recognized and appreciated the need to improve various aspects of a treatment system and treatment methods.

### SUMMARY

The present disclosure is directed generally to aspects of a treatment system, and, more specifically, one or more aspects of a treatment system that reduces or increases pH levels to a circum-neutral range and/or optionally remediates one or more heavy metals. For example, some aspects of the present disclosure are directed to entire treatment systems and methods that reduce or increase pH levels of an aqueous stream to a circum-neutral range and/or remediate heavy metals therein. Also, for example, some aspects of the present disclosure are directed to entire treatment systems and methods that reduce or increase pH levels of a CCR supply to a circum-neutral range and/or remediate heavy metals therein. Some aspects of the present disclosure are directed to one or more aspects of a treatment system and method such as, for example: particle reactor(s) of the system, reaction process(es), CCR feeding structure(s), milling process(es), CCR feeding process(es), dewatering process(es), dewatering structure(s), heavy metals removal, treated water recirculation process(es), treated water recirculation system(s), instrumentation of the system, sensors of the system, monitoring of the system, and/or other structural aspects of and/or methods related to a treatment system.

The term “controller” is used herein generally to describe various apparatus relating to the operation of one or more aspects of a treatment system. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), programmable logic controllers (PLCs), and field-programmable gate arrays (FPGAs).

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, one or more mouse, keyboards, keypads, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a schematic view of an embodiment of a treatment system.

FIG. 2 illustrates a more detailed schematic view of an embodiment of the particle reactor of FIG. 1.

FIG. 3 illustrates a flowchart showing an embodiment of a neutralization process utilizing the particle reactor of FIG. 1.

FIG. 4 illustrates a schematic view showing an embodiment of the dewatering structure of the treatment system of FIG. 1.

FIGS. 5A-5C illustrate a listing of process equipment symbols that may be utilized in the schematics of FIGS. 14-28 that illustrate another embodiment of a treatment system.

FIG. 6 illustrates notes related to instrumentation symbols of FIG. 7.

FIG. 7 illustrates a listing of instrumentation symbols that may be utilized in the schematics of FIGS. 14-28.

FIG. 8 illustrates a listing of line designations that may be utilized in the schematics of

FIGS. 14-28.

FIG. 9 illustrates a listing of abbreviations that may be utilized in the schematics of

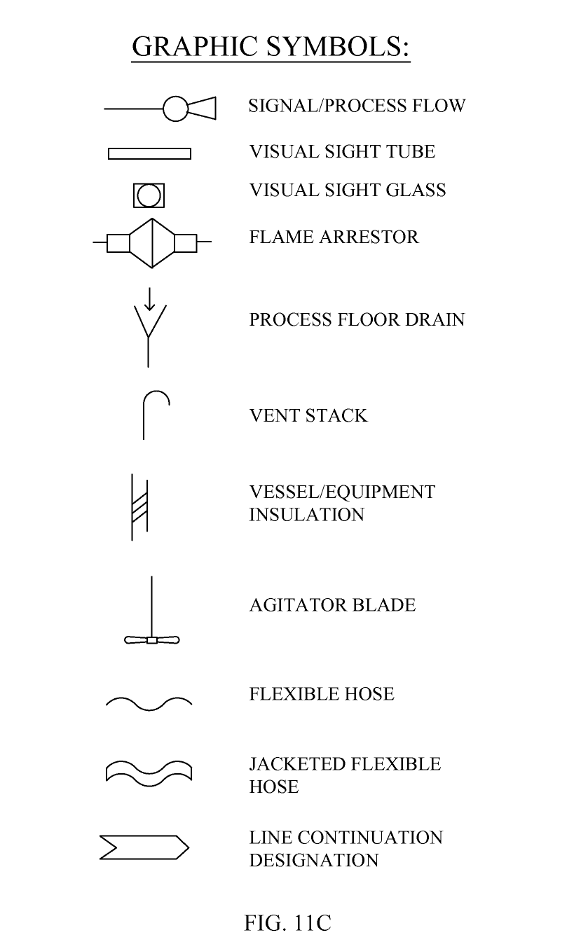

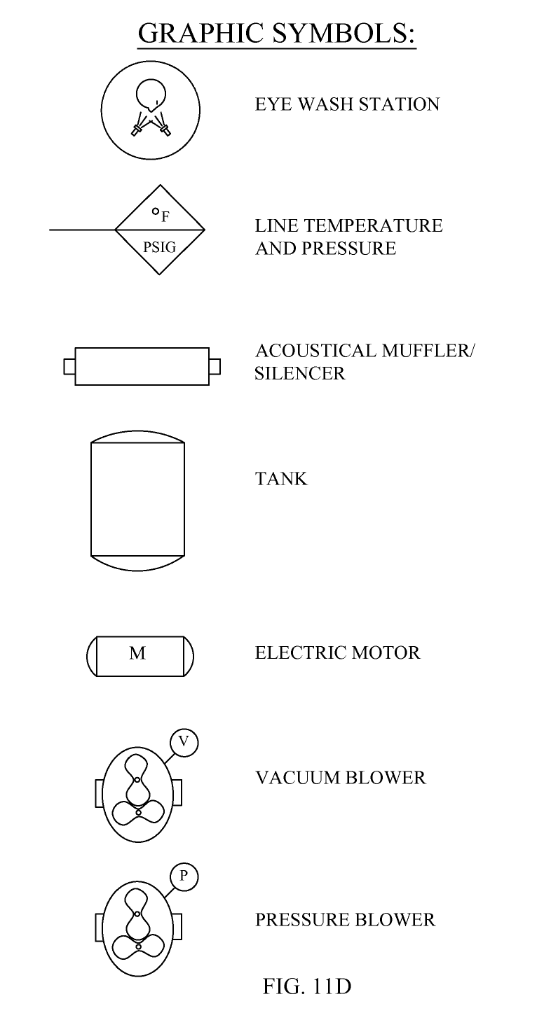

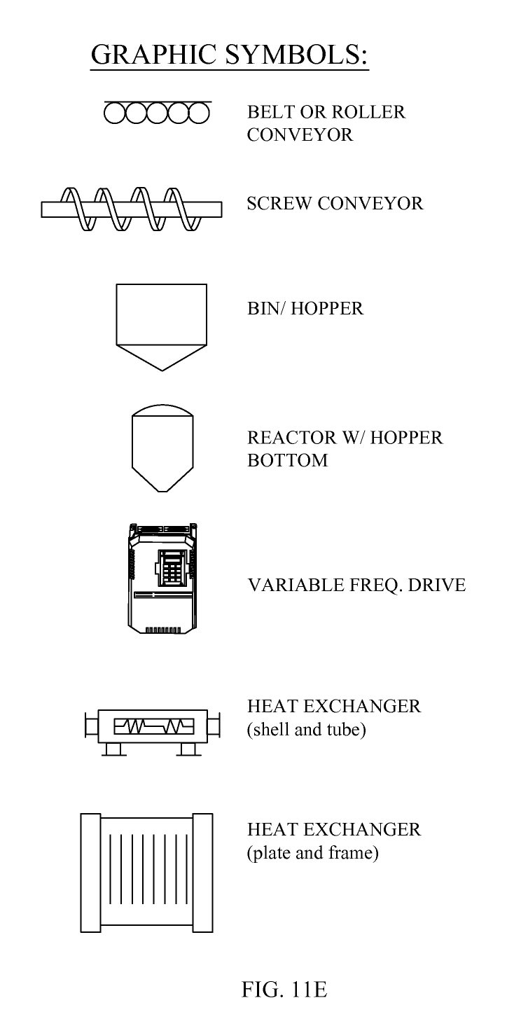

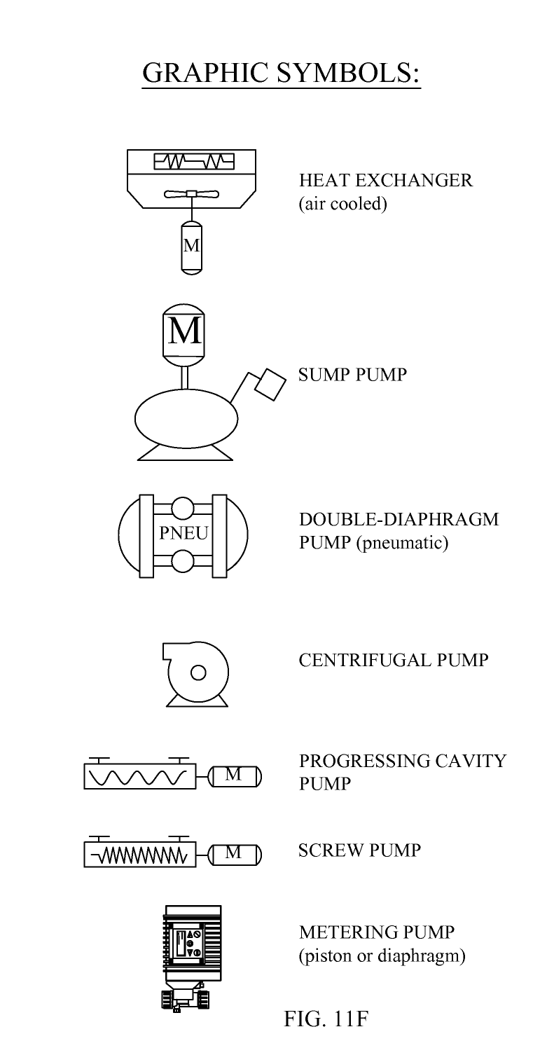

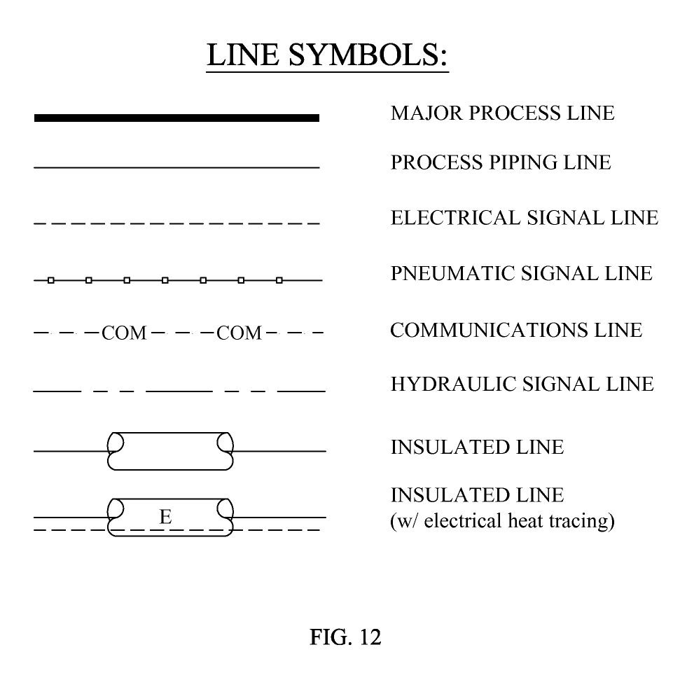

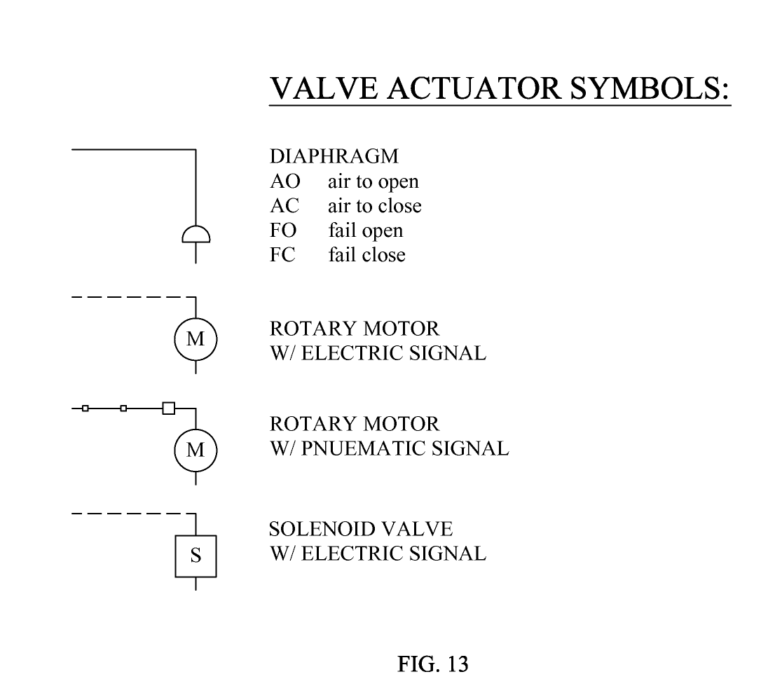

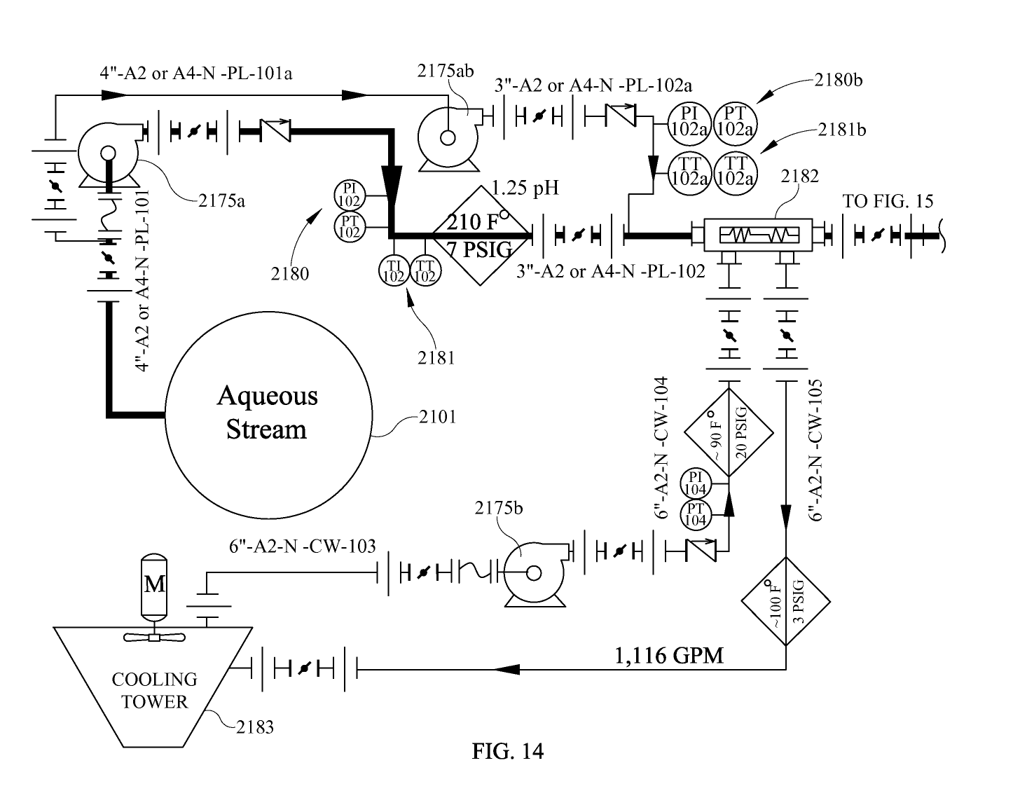

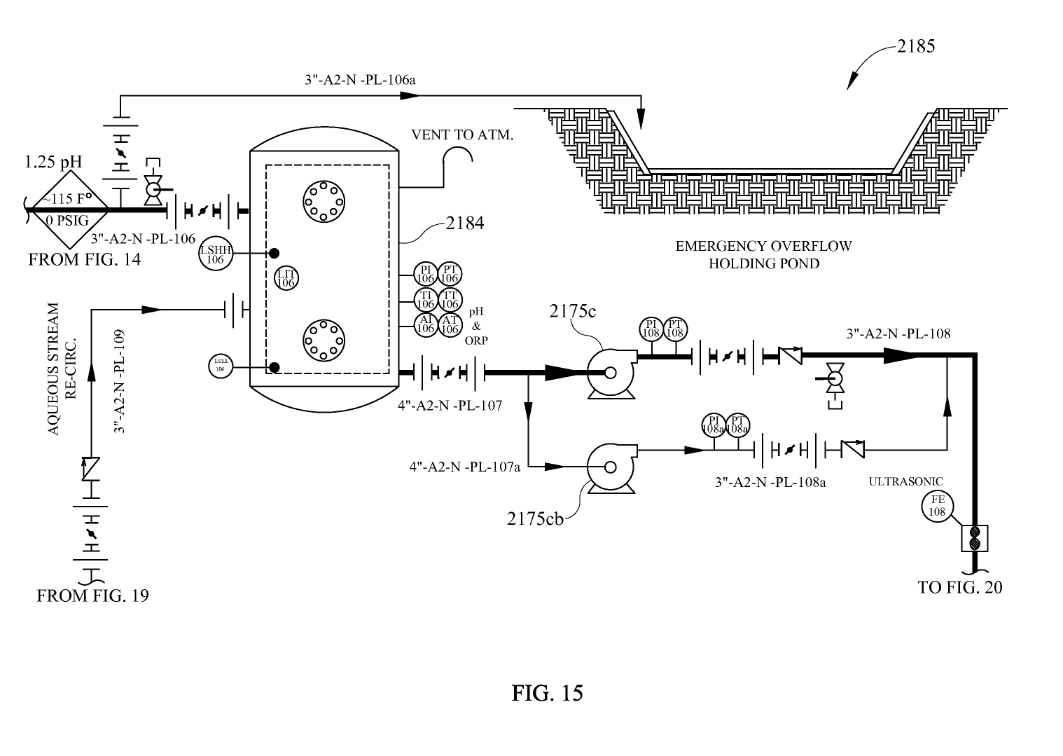

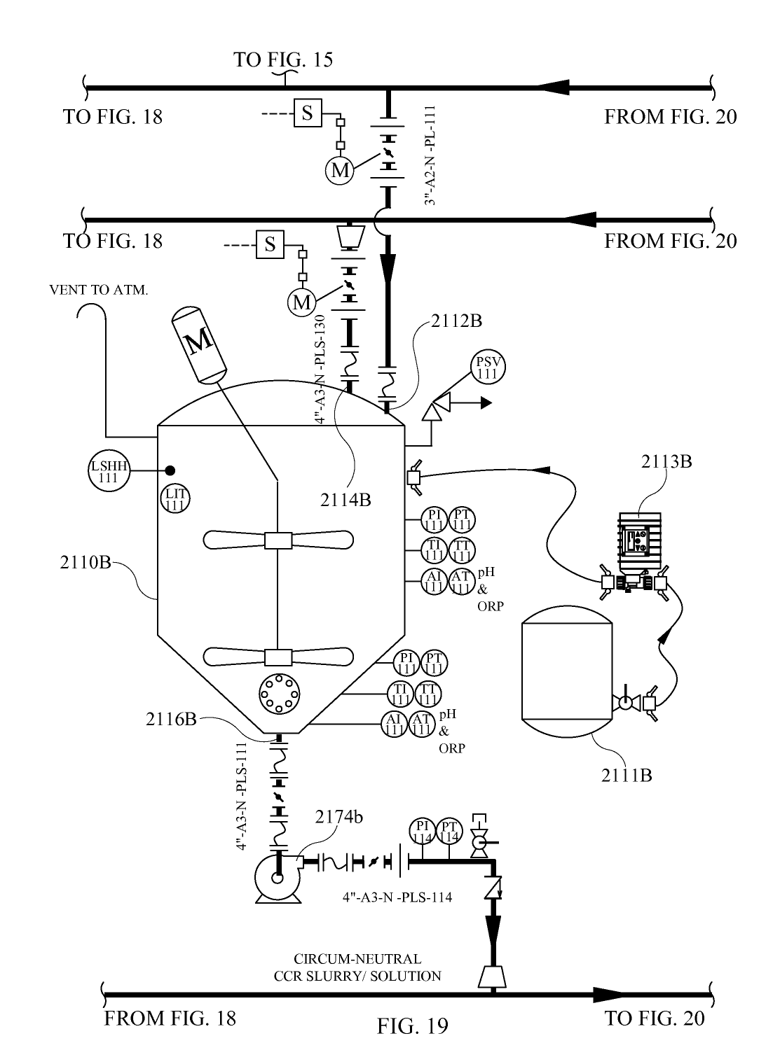

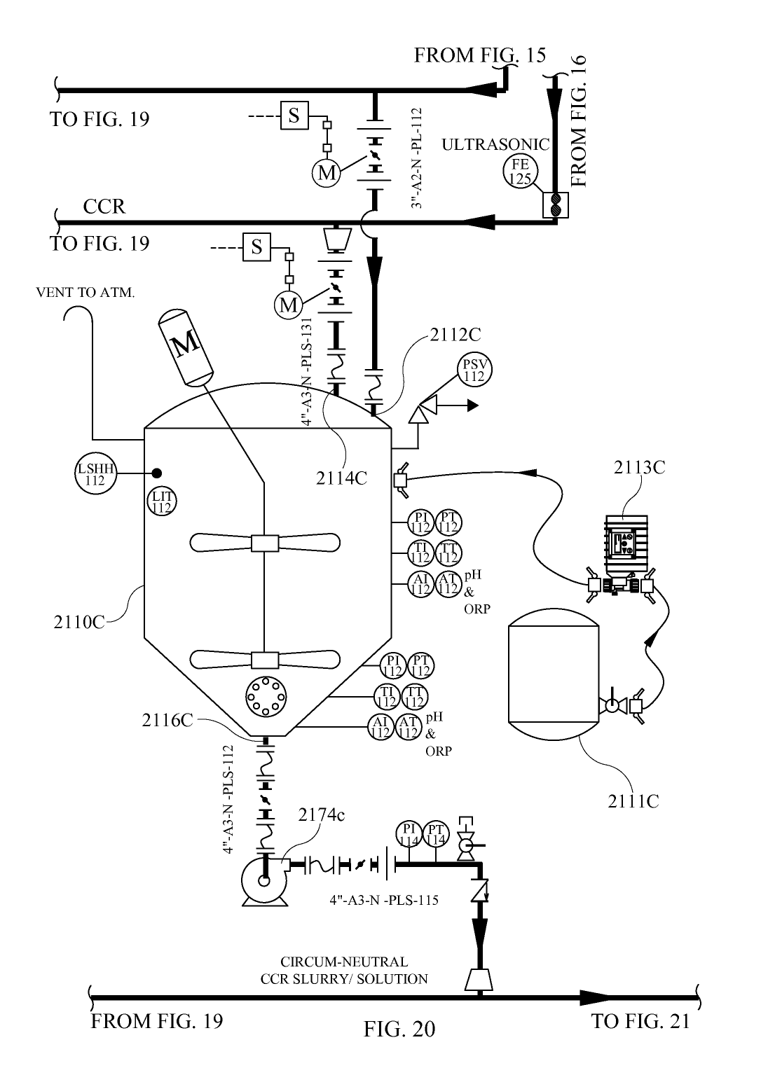

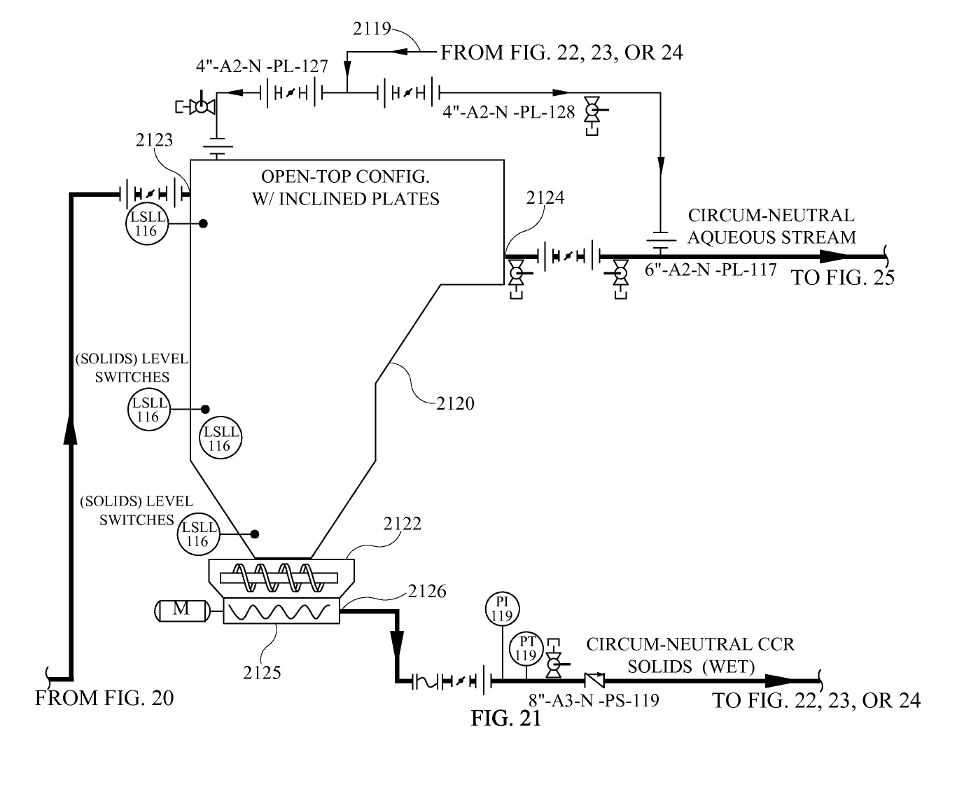

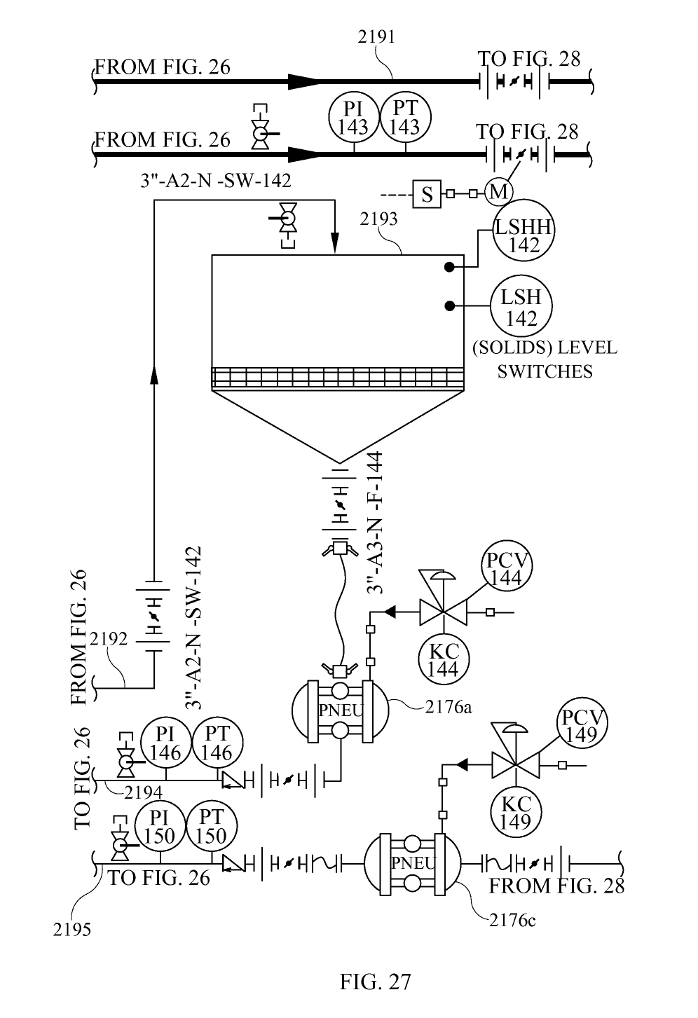

FIGS. 14-28.

FIGS. 10A and 10B illustrate a listing of valve symbols that may be utilized in the schematics of FIGS. 14-28.

FIGS. 11A-11F illustrate a listing of graphic symbols that may be utilized in the schematics of FIGS. 14-28.

FIG. 12 illustrates a listing of line symbols that may be utilized in the schematics of

FIGS. 14-28.

FIG. 13 illustrates a listing of valve actuator symbols that may be utilized in the schematics of FIGS. 14-28.

FIGS. 14 through 28 illustrate schematics of another embodiment of a treatment system.

FIG. 29 illustrates an overview of certain aspects of the treatment system of the schematics of FIGS. 14 through 28.

### DETAILED DESCRIPTION

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the representative embodiments. Such methods and apparatuses are clearly within the scope of the claimed invention. For example, the aspects of a treatment system disclosed herein are often described in conjunction with a treatment system having a specific configuration. However, one or more aspects of the treatment system described herein may be implemented in treatment systems having other configurations and implementation of the one or more aspects described herein in alternatively configured treatment systems is contemplated without deviating from the scope or spirit of the claimed invention. Also, for example, many aspects of a treatment system disclosed herein are described in conjunction with a treatment system that reduces or increases pH levels of a waste stream and/or CCR supply to a circum-neutral range and also remediates one or more heavy metals in the waste stream and/or CCR supply. However, such aspects of a treatment system described herein may be implemented in treatment systems that do not remove heavy metals from the waste stream. Also, for example, aspects of a treatment system described herein may be implemented in combination with a stream that is not necessarily a waste stream. For example, aspects of a treatment system described herein may be implemented utilizing a non-waste stream to neutralize and/or remove metals from CCR.

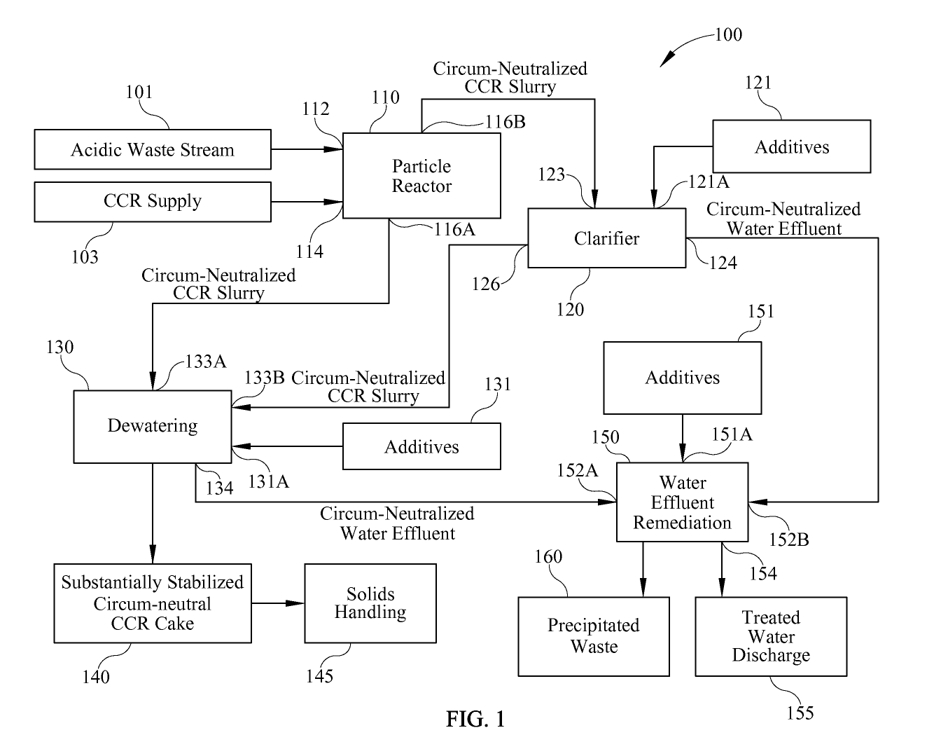

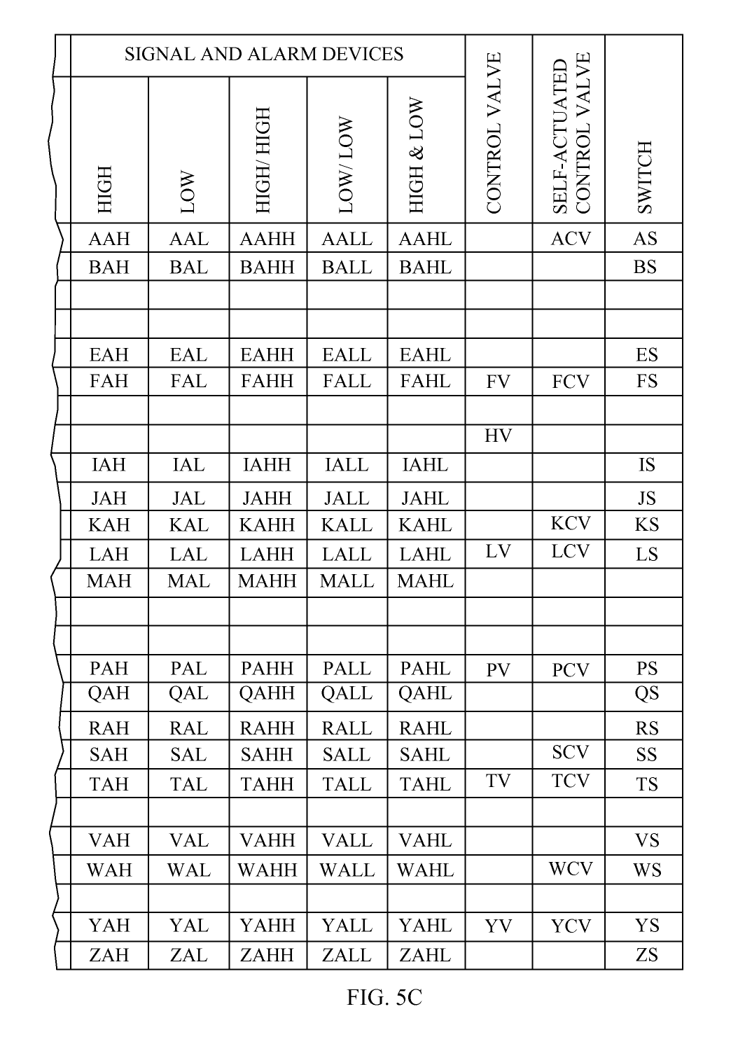

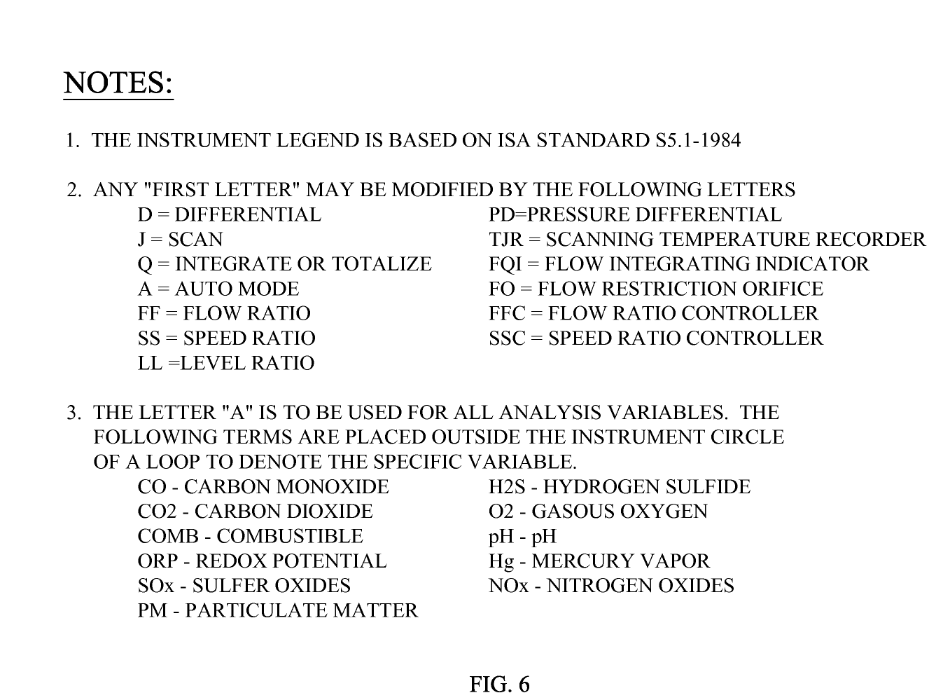

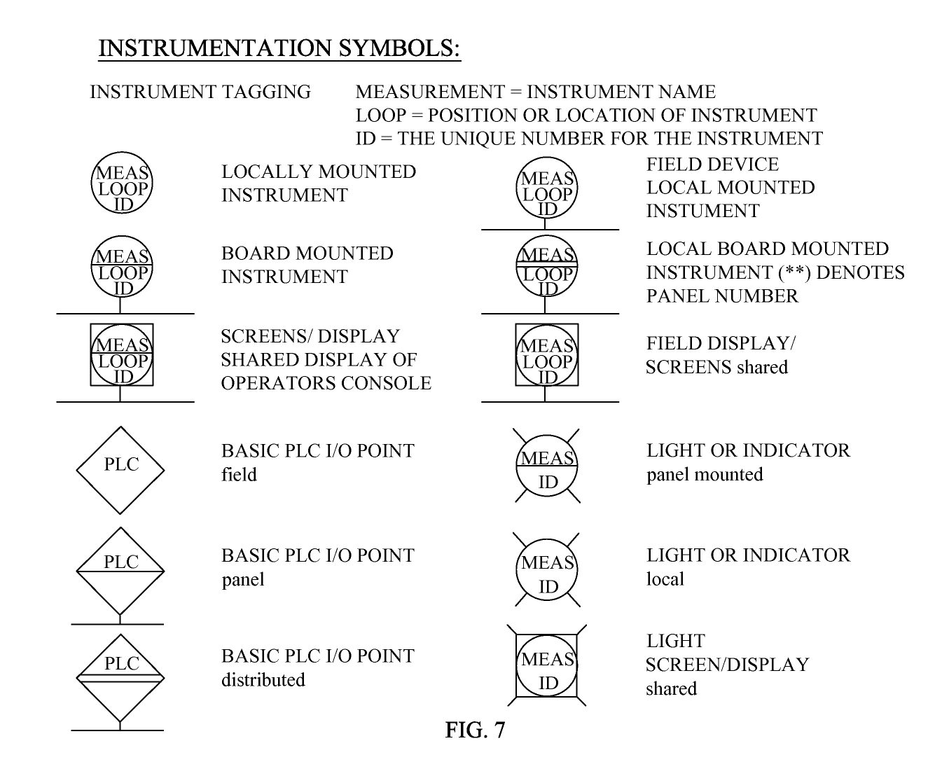

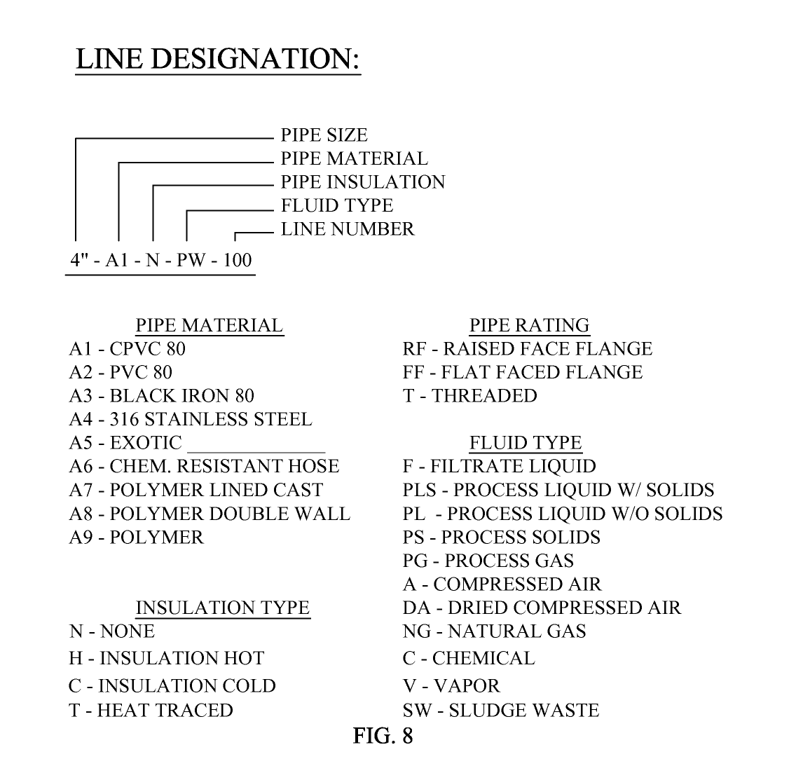

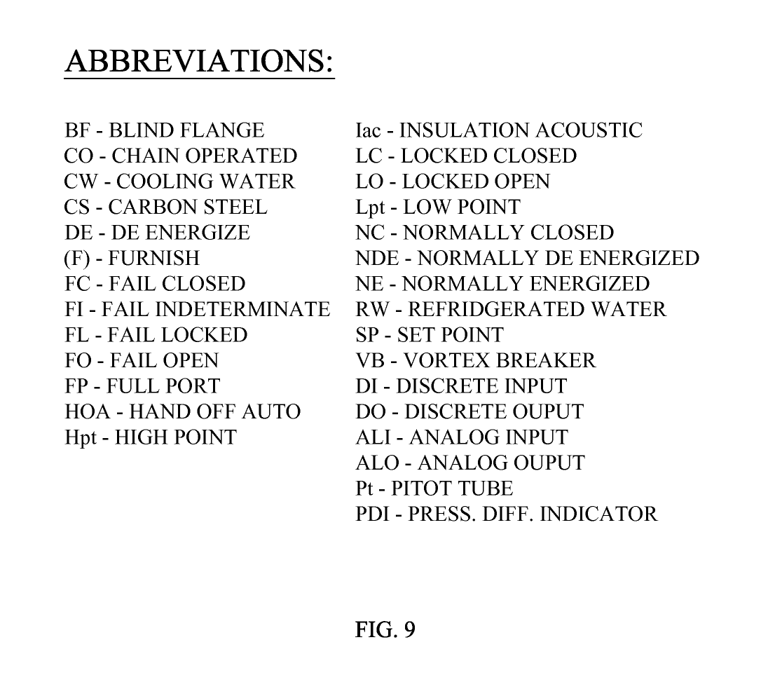

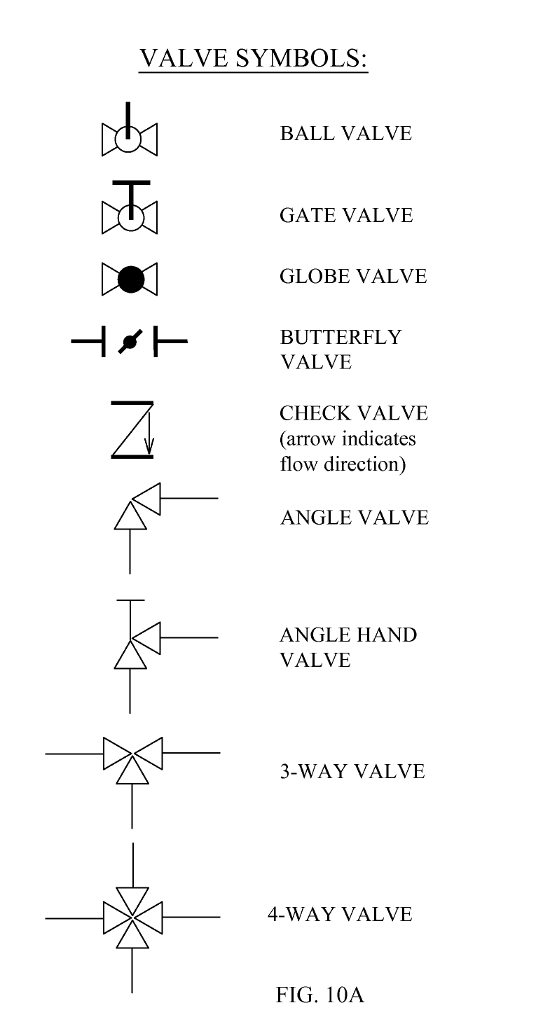

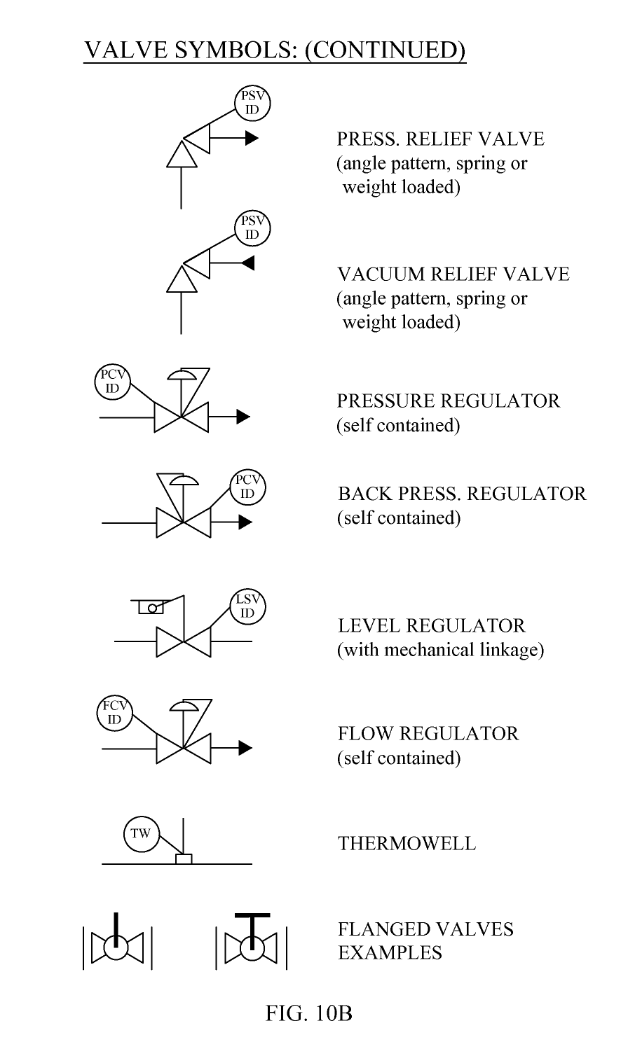

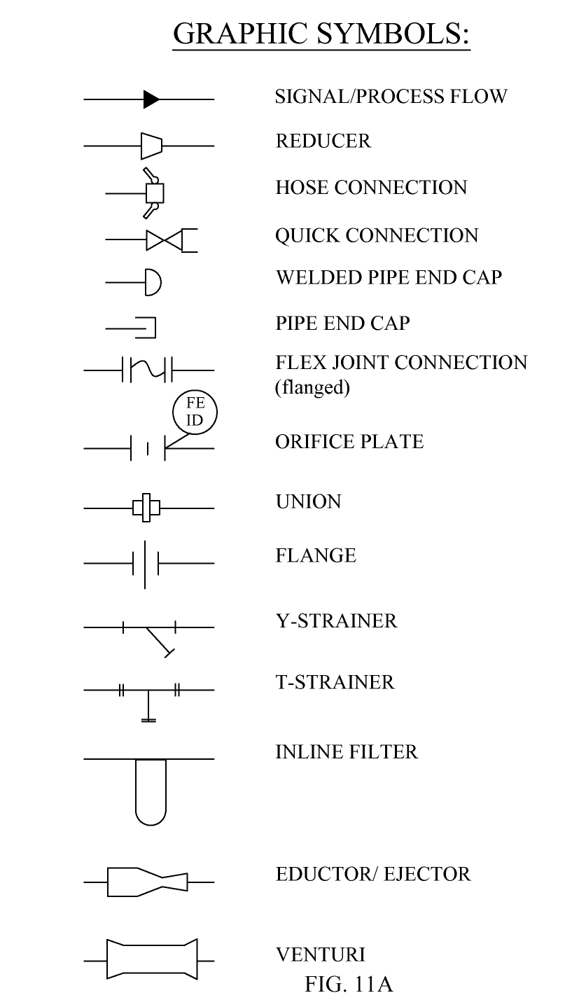

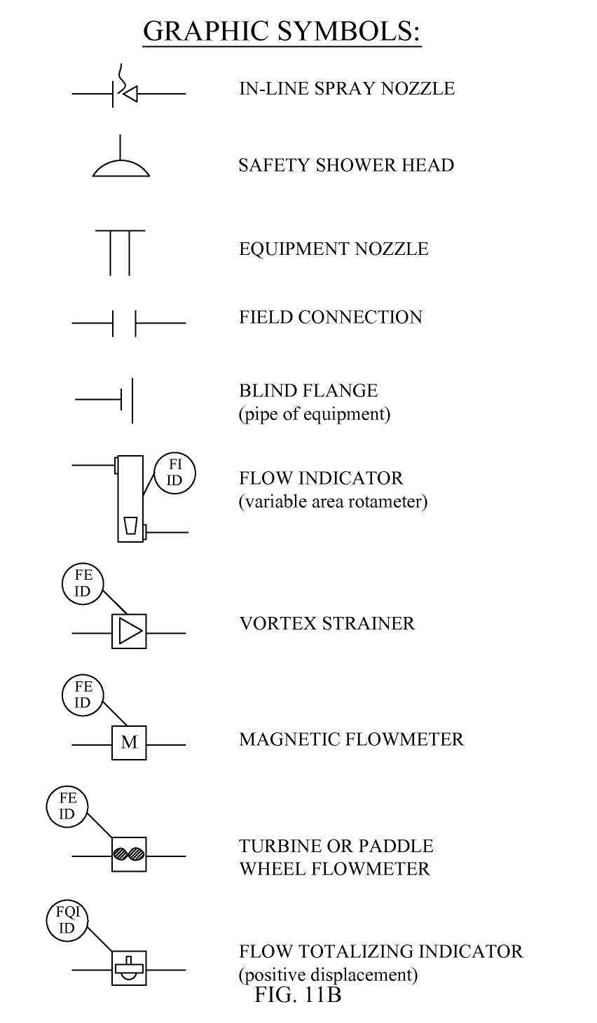

In FIG. 1 through FIG. 4 various aspects of a first embodiment of a treatment system 100 are shown. In FIGS. 5A-29 various aspects of a second embodiment of a treatment system 2100 are shown. One of ordinary skill in the art, having had the benefit of the present disclosure, will recognize and appreciate that in some embodiments a treatment system may include aspects of the first embodiment of the treatment system 100, aspects of the second embodiment of the treatment system 2100, and/or aspects of other embodiments of the treatment system described herein. For example, one of ordinary skill in the art, having had the benefit of the present disclosure, will recognize and appreciate that alternatives to certain apparatus and/or methods that are discussed in combination with one of the treatment systems 100 and 2100 may be applied to other of the treatment systems 100 and 2100. For example, various apparatus and methods that are described as potentially being utilized in performing and/or monitoring a reaction in treatment system 100 may optionally be utilized in treatment system 2100, and vice versa. Also, for example, one of ordinary skill in the art, having had the benefit of the present disclosure, will recognize and appreciate that certain components and/or upstream and/or downstream connections between components that are discussed in combination with one of the treatment systems 100 and 2100 may be applied to the other of the treatment systems 100 and 2100.

Moreover, one of ordinary skill in the art, having had the benefit of the present disclosure, will recognize and appreciate that in some embodiments a treatment system may only include one or more of certain components and/or certain methods of the embodiments of the treatment system described herein.

Referring initially to FIG. 1, a schematic view of the first embodiment of the treatment system 100 is shown. The treatment system 100 is in communication with an aqueous stream, such as a waste stream, or in some embodiments an acidic waste stream 101 and a CCR supply 103. The acidic waste stream 101 is aqueous, has generally acidic properties, and may originate from one or more of a variety of sources. For example, in some embodiments the acidic waste stream 101 may be derived, in whole or in part, from a stream of liquid utilized in a wet scrubber, venturi scrubber, and/or other pollution abatement system that utilizes liquid to remove one or more pollutants (e.g., nitrogen, carbon dioxide, carbon monoxide, unburned hydrocarbons, oxides of sulfur, particulates , and/or oxides of nitrogen). Also, for example, in some embodiments the acidic waste stream 101 may be derived, in whole or in part, from a liquid utilized in a pulp mill. Also, for example, in some embodiments the acidic waste stream 101 may be derived, in whole or in part, from liquid utilized in fertilizer production, liquid utilized in pickling processes, and/or mine drainage. Acidic waste stream 101 need not constitute a continuous flow of liquid and may instead only be a selective, periodic, or intermittent flow of liquid.

The acidic waste stream 101 may be delivered to the particle reactor 110 utilizing piping, one or more channels, and/or other conduit in some embodiments. In those embodiments the acidic waste stream 101 may be transported through the conduit utilizing, for example, gravity, one or more pumps, and/or other means. The acidic waste stream 101 may optionally be cooled and/or heated prior to delivery to the treatment system 100 and may optionally be diluted or concentrated through the addition or removal of liquid prior to delivery to the treatment system 100. For example, in some embodiments the acidic waste stream 101 may be stored in a tank and allowed to cool prior to delivery to the treatment system 100. In alternative embodiments the acidic waste stream 101 may additionally or alternatively be delivered utilizing a transportable liquid storage tank. One of ordinary skill in the art, having had the benefit of the present disclosure, will recognize and appreciate that in alternative embodiments other acidic waste streams may be utilized and that such waste streams may optionally be alternatively delivered to the treatment system 100. Moreover, although an acidic waste stream 101 is depicted in the embodiment of FIG. 1, it is understood that in alternative embodiments the waste stream 101 may be a basic (non-acidic) waste stream.

The CCR supply 103 is a coal-based, substantially alkaline supply that may originate from one or more of a variety of sources. For example, in some embodiments the CCR supply 103 may include one or more related constituents such as fly ash, bottom ash, coal slag, boiler slag, fluidized bed combustion (FBC) residue, gypsum, and/or flue gas desulfurization (FGD) residue. The CCR supply 103 may be derived, in whole or in part, from the combustion of coal in a coal-fired power plant. For example, in some embodiments fly ash may be collected from filters/precipitators of a coal-fired power plant and bottom ash may be collected from the furnace source of a coal-fired power plant. In some embodiments the CCR supply 103 may be generated in close proximity to the water treatment system 100. For example, in some embodiments the CCR supply 103 may be generated from the combustion of coal in a coal-fired power plant and the treatment of the flue gas from the same coal-fired power plant may also generate the acidic waste stream 101. In some embodiments the CCR supply 103 may additionally or alternatively be transported from a remote location. For example, the CCR supply 103 may be transported from a remote coal-fired power plant.

The CCR supply 103 may be delivered to the particle reactor 110 utilizing piping, one or more channels and/or other conduits in some embodiments. In those embodiments the CCR supply 103 may be transported through the conduit utilizing, for example, gravity, one or more pumps, the addition of a liquid, vibratory equipment, and/or other means. In other embodiments the CCR supply 103 may additionally or alternatively be delivered utilizing a conveyor belt, a transportable storage container, a vehicle, or other delivery means. In some embodiments that treat an acidic waste stream, the CCR supply 103 may have a pH of approximately 10 to 14. In some embodiments the size of some or all of the CCR particles may be reduced to fall generally within a predetermined range of sizes. For example, in some embodiments the CCR may be mechanically ground to reduce the size of various particles thereof. For example, a batch mill, a media mill, a hammer mill, a grinding mixer, dry mill, wet mill, jet mill, ball mill, roller mill, vibrating mill, S.A.G. mill, autogenous mill, disc mill, and/or pebble mill may be utilized to reduce the size of particles of the CCR supply 103.

In some embodiments some or all of the CCR supply 103 may optionally be ground to reduce the size of most particles to approximately one millimeter or less in diameter. In some embodiments the desired particle size may be dependent on one or more of the pH of the CCR supply 103, the pH of the acidic waste stream 101, and the particular combustion process being utilized at a location. Size reduction of the CCR supply 103 may increase reactivity of the CCR supply 103 and/or may standardize the CCR supply to thereby enable generally predictable and/or consistent reactions. Generally speaking, it may be desirable in some embodiments where grinding of the CCR supply 103 occurs to grind CCR supplies having a relatively low pH more aggressively to thereby obtain a smaller average particle size. Also, generally speaking, it may be desirable in some embodiments where grinding of the CCR supply 103 occurs to grind CCR supplies to a degree relative to the acidic or alkaline conditions of the particular CCR supply 103.

In some embodiments the CCR supply 103 may be ground for a given amount of time to achieve a desired average particle size. The amount of time the CCR supply 103 is ground may be dependent on, inter alio, the original size of the particles of the CCR supply 103, the chemical properties of the CCR supply 103, the source of the CCR supply 103, the pH of the acid waste stream 101, and/or the desired pH of treated stream effluent. In some embodiments samples of the CCR supply 103 may be analyzed to approximate average particle size, range of particle sizes, mean particle size, etc. For example, in some embodiments a sample of ground CCR supply 103 may be placed in an atomizer and measured with a laser to determine an approximate average particle size.

One of ordinary skill in the art, having had the benefit of the present disclosure, will recognize and appreciate that in alternative embodiments other CCR supplies may be utilized and that such CCR supplies may optionally be alternatively delivered to the treatment system 100. Moreover, although an alkaline CCR supply configured to reduce the acidity of acidic waste stream 101 is depicted in the embodiment of FIG. 1, it is understood that in alternative embodiments the CCR supply 103 may be acidic and optionally utilized to neutralize a basic waste stream.

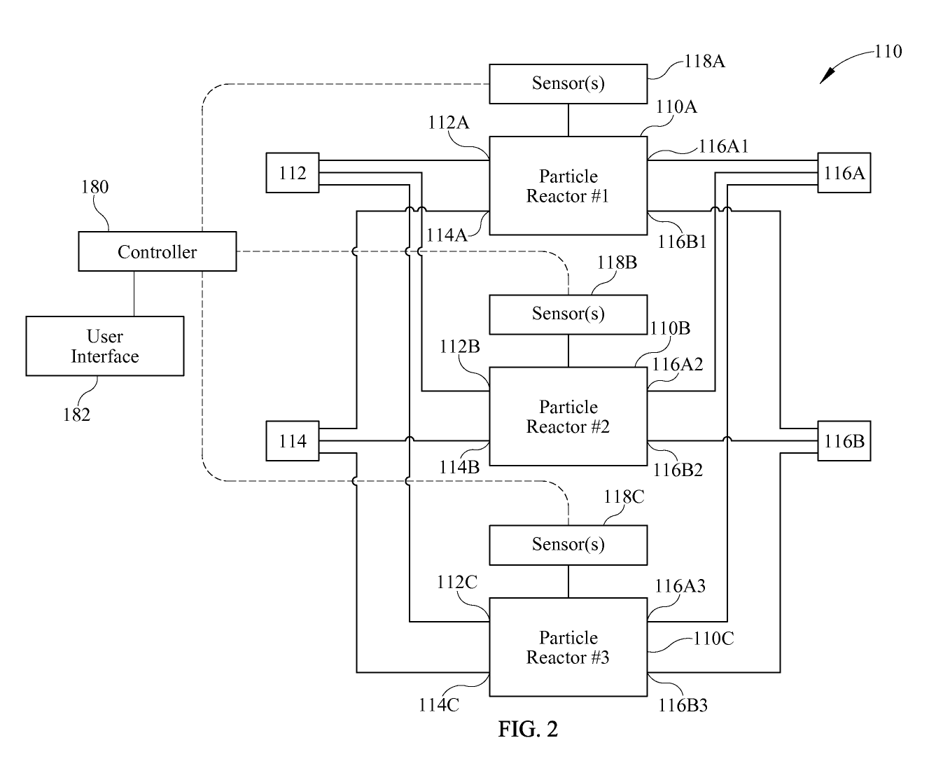

The acidic waste stream 101 is fed into an acidic waste stream intake 112 of the particle reactor 110 and the CCR supply 103 is fed into a CCR intake 114 of the particle reactor 110. Generally speaking, the particle reactor 110 stores a quantity of the acidic waste stream 101 and a quantity of the CCR supply 103 and optionally facilitates the reaction thereof to thereby form a circum-neutral CCR slurry. As used herein, the terms circum-neutral and circum-neutralized are associated with a pH of the item(s) referenced. In some embodiments the terms circum-neutral and/or circum-neutralized reference a pH of between approximately 4 and 10. In some versions of those embodiments the terms circum-neutral and/or circum-neutralized reference a pH between approximately 6 and 9. In some embodiments the terms circum-neutral and/or circum-neutralized reference a pH that is based on obtaining compliance with one or more permits and/or tests. Although certain items are referenced as being circum-neutral or circum-neutralized in one or more embodiments described herein, one of ordinary skill in the art, having had the benefit of the present disclosure, will recognize and appreciate that in other embodiments one or more of such items may not be circum-neutral or circum-neutralized. For example, in some embodiments it may be desirable to temporarily raise or lower the pH of CCR slurry and/or water effluent during one or more aspects of the treatment method described herein to assist in the precipitation of certain metals. The ratio of the quantity of acidic waste stream 101 to CCR supply 103 within particle reactor 110 at one time may depend on one or more of a variety of factors. For example, the ratio may be dependent on the pH of the CCR supply 103, the pH of the acidic waste stream 101, the particle size distribution of the CCR supply 103, the desired output pH of the reacted CCR slurry, the temperature of the acidic waste stream 101, the presence of any reaction additives that may optionally be added to the mixture, and/or the desired reaction rate. Although an acidic waste stream intake 112 and a separate CCR intake 114 are depicted in FIG. 1 and FIG. 2, one of ordinary skill in the art having had the benefit of the present disclosure will recognize and appreciate that acidic waste stream intake 112 and CCR intake 114 may form a single intake in some embodiments. For example, in some embodiments the acidic waste stream intake 112 and CCR intake 114 may be an actuable lid or cover that, when open, enables the receipt of an acidic waste stream 101 (for example, from an overhead conduit) and CCR supply 103 (for example, from an overhead hopper).

The particle reactor 110 may optionally include one or more mechanical mixers, jets, vibratory equipment, spinning equipment, tilting equipment, sieving apparatus, segregating apparatus, and/or other agitator and/or actuator to facilitate the mixing and/or reacting of the quantity of acidic waste stream 101 and quantity of CCR supply 103. As described in detail herein, the particle reactor 110 retains the quantity of acidic waste stream 101 and the quantity of CCR supply 103 for an amount of time that is sufficient to enable the two to react such that a pH level of the CCR slurry within a sufficient range of pH levels is obtained. In some embodiments the sufficient range of pH levels may be between approximately 6 and 9. In some embodiments the sufficient range of pH levels may be between approximately 4 and 10. For example, the particle reactor 110 may retain the quantity of acidic waste stream 101 and CCR supply 103 for a predetermined amount of time to thereby obtain substantially neutral CCR slurry. Also, for example, the particle reactor 110 may retain the quantity of acidic waste stream 101 and CCR supply 103 for an amount of time that is determined, in whole or in part, by one or more of a sensor and/or human observation to thereby obtain substantially circum-neutral CCR slurry. Once the quantity of acidic waste stream 101 and CCR supply 103 is sufficiently reacted, the particle reactor(s) 110 output circum-neutral CCR slurry over at least one of first circum-neutral slurry output 116A and second circum-neutral slurry output 116B. In alternative embodiments, only one of first and second circum-neutral CCR slurry outputs 116A and 116B may be provided.

Referring to FIG. 2, a more detailed schematic view of an embodiment of the particle reactor 110 of FIG. 1 is illustrated. The particle reactor 110 includes three individual particle reactors: a first particle reactor 110A, a second particle reactor 1106, and a third particle reactor 110C. In alternative embodiments more or fewer individual particle reactors may be provided. For example, a single individual particle reactor may be provided in some embodiments. Also, for example, more individual particle reactors may be provided in some embodiments to increase capacity and/or to provide redundancy. One or more of the individual particle reactors 110A-C may optionally be in thermal communication with a heat exchanger, chiller, or other heat dissipating device to strip away heat that may be generated during exothermic reactions within the individual particle reactors 110A-C.

Each of the individual particle reactors 110A-C has an individual waste stream intake 112A-C that is in selective communication with waste stream intake 112. For example, the waste stream intake 112 may include actuable three way valve structure that selectively blocks acidic waste stream 101 or routes it to a single one of individual waste stream intakes 112A-C. The valve structure may be in communication with each of individual waste stream intakes 112A-C, for example, via individual conduits each extending between the valve structure and a single one of individual waste stream intakes 112A-C.

The valve structure associated with waste stream intake 112 (or other structure(s) utilized to selectively feed acidic waste stream 101 to one or more of individual particle reactors 110A-C) may be actuated manually and/or may be automatically actuated. In some embodiments the valve structure may be in electrical communication with a controller 180 that directs which, if any, of the individual waste stream intakes 114A-C is being filled with the acidic waste stream 101 at a given time. For example, the controller 180 may operate to actuate valve structure of waste stream intake 112 to direct flow to a unique one of the individual waste stream intakes 112A-C at predetermined intervals. The controller 180 may send a signal to an actuator (e.g., hydraulic, pneumatic, mechanical, electrical) to actuate valve structure such that flow from acidic waste stream 101 is directed toward waste stream intake 112A for an amount of time, waste stream intake 112B for an amount of time, and then to waste stream intake 112C for an amount of time. Optionally, the controller 180 may send a signal to the actuator to actuate the valve structure such that flow from acidic waste stream 101 is halted for an amount of time in between one or more of the diversions between waste stream intakes 112A-C.

Also, for example, the controller 180 may additionally or alternatively operate to actuate valve structure of waste stream intake 112 to direct flow to a unique one of the individual waste stream intakes 112A-C in response to operator input at user interface 182. For example, a user may monitor the status of one or more of individual particle reactors 110A-C, acidic waste stream 101, CCR supply 103, and/or sensors 118A-C and provide input concerning same to controller 180 via user interface 182. Each of sensors 118A-C may sense one or more characteristic associated with a respective particle reactor 110A-C. The controller 180 may utilize the input, in whole or in part, to selectively direct flow to a unique one of the individual waste stream intakes 112A-C.

Also, for example, the controller 180 may additionally or alternatively operate to actuate valve structure of waste stream intake 112 to direct flow to a unique one of the individual waste stream intakes 114A-C in whole or in part in response to electrical input from one or more of the sensors 118A-C. For example, the sensors 118A-C may each include one or more sensors that monitor whether a respective particle reactor 110A-C is empty or full. Such sensors may include, for example, a mechanical switch, proximity sensor, hall-effect sensor, and/or optical sensor that may indicate, for example: when one or more valves utilized to evacuate a respective particle reactor 110A-C has been opened/closed (the controller 180 may determine if the length of time between opening and closing is a sufficient amount of time for full evacuation); when a lid for cleaning a respective particle reactor 110A-C has been opened/closed (the controller 180 may determine if the length of time between opening and closing is a sufficient amount of time for cleaning); when an operator has actuated a button, lever, or other tactile object (for example, a lever to evacuate one or more particle reactors 110A-C), thereby indicating one or more of the particle reactors 110A-C are ready for receipt of flow from the acidic waste stream 101.

Each of the individual particle reactors 110A-C also has individual CCR supply intakes 114A-C that are in selective communication with CCR supply intake 114. For example, the CCR supply intake 114 may include actuable diversion structure that selectively blocks CCR from CCR supply 103 or diverts it to a single one of individual CCR supply intakes 114A-C. The diversion structure may be in communication with each of individual CCR supply intakes 114A-C via, for example, individual optionally vibratory conduits and/or conveyors each extending between the diversion structure and a single one of individual CCR supply intakes 114A-C.

The diversion structure associated with CCR intake 114 (or other structure(s) utilized to selectively feed CCR supply 103 to one or more of individual particle reactors 110A-C) may be actuated manually and/or may be automatically actuated. In some embodiments the diversion structure may be in electrical communication with the controller 180 and/or other controller. The controller 180 may dictate which, if any, of the individual CCR intakes 114A-C is being filled with the CCR supply 103 at a given time. For example, the controller 180 may operate to actuate diversion structure of CCR intake 114 to direct CCR supply 103 to a unique one of the individual CCR intakes 116A-C at intervals based, in whole or in part, upon the anticipated quantity of generated acidic waste stream 101, which may be based upon, for example, a production schedule or other data. The controller 180 may send a signal to a hydraulic or mechanical actuator to actuate diversion structure such that CCR supply 103 is directed toward CCR intake 114A for an amount of time, CCR intake 114B for an amount of time, and CCR intake 114C for an amount of time. Optionally, the controller 180 may send a signal to the actuator to actuate diversion structure such that input from CCR supply 103 is halted for an amount of time in between one or more of the diversions between CCR intakes 114A-C.

Also, for example, the controller 180 may additionally or alternatively operate to actuate diversion structure of CCR intake 114 to direct input to a unique one of the individual CCR intakes 114A-C in response to operator input at user interface 182. For example, a user may input data concerning the anticipated output quantity and/or output pH of acidic waste stream 101, the anticipated output quantity and/or output pH of CCR supply 103, and/or data concerning any additives that may be utilized in the reaction process to controller 180 via user interface 182. The controller 180 may utilize the input, in whole or in part, to direct input to a unique one of the individual CCR intakes 114A-C for an amount of time.

Also, for example, the controller 180 may additionally or alternatively operate to actuate diversion structure of CCR intake 114 to direct output to a unique one of the individual CCR intakes 114A-C in whole or in part in response to electrical input from one or more of the sensors 118A-C. For example, the sensors 118A-C may each include one or more sensors that monitor quantity and/or acidity of an amount of acidic waste stream 101 that may be present in the respective particle reactor 110A-C. Such sensors may include, for example, a pH electrode to measure the pH of the quantity of acidic waste stream 101 that may be present in the respective particle reactor 110A-C, a flow meter at waste stream intake 112 or flow meters at respective waste stream intakes 112A-C to measure the quantity of acidic waste stream 101 that may be present in the respective particle reactor 110A-C, and/or a conductivity sensor to estimate the quantity and/or pH of the acidic waste stream 101 that may be present in the respective particle reactor 110A-C.

Examples are provided herein of how to actuate diversion structure associated with CCR intake 114 (or other structure(s) utilized to selectively feed CCR supply 103 to one or more of individual particle reactors 110A-C) to direct a desired quantity of CCR supply 103 to a unique one of the individual CCR intakes 114A-C. Similarly, separate examples are provided herein of how to actuate the valve structure associated with waste stream intake 112 (or other structure(s) utilized to selectively feed acidic waste stream 101 to one or more of individual particle reactors 110A-C) to direct a desired quantity of acidic waste stream 101 to a unique one of the individual waste stream intakes 112A-C. It is understood that examples that apply to the CCR intake 114 may also be generally applicable to the waste stream intake 112, and vice versa. Moreover, it is understood that alternative and/or additional apparatus may be utilized in determining how much of a waste stream and/or CCR to feed into an individual particle reactor 110A-C and when to feed such waste stream and/or CCR. Moreover, it is understood that alternative structure(s) to the valve structure and diversion structure described herein and/or alternative methodologies may be utilized to direct a waste stream and/or CCR to an individual particle reactor 110A-C. Moreover, it is understood that combinations of the methodologies described herein may be utilized. For example, controller 180 may analyze input from user interface 182 in addition to input from one or more sensors 118A-C. Moreover, it is understood that one or more aspects of apparatus and/or methods described herein that relate to particle reactor 110 (e.g., feeding of particle reactor 110, monitoring of reactions of particle reactor 110, and/or discharge of particle reactor 110) may be applied to particle reactor 2110, and vice versa.

Although not illustrated, in some embodiments one or more of the individual particle reactors 110A-C may also optionally be supplied with one or more additives to facilitate the reaction between a quantity of CCR supply 103 and a quantity of acidic waste stream 101. For example, the additives may include, for example, reagent(s) that influence the chemical reaction between the quantity of CCR supply 103 and the acidic waste stream 101 and/or pH additives that alter the pH of the circum-neutralized slurry that is produced by such reaction (e.g., chelants, ligands, complexing agents, sequestering agents, oxidants, and/or reductants). The additives may be selectively added, intermittently added, periodically added, and/or continuously added. The additives may be stored in a storage container and selectively added to particle reactors 110A-C via a separate intake, through one or more of intakes 112, 114, or other intake, and/or may be mixed with the acidic waste stream 101 and/or the CCR supply 103 before they are received in the one or more particle reactors 110A-C.

Each of the individual particle reactors 110A-C also has individual first circum-neutralized slurry outputs 116A1-A3 that are in communication with circum-neutralized slurry output 116A and individual second circum-neutralized slurry outputs 116B1-B3 that are in selective communication with circum-neutralized slurry output 116B. The circum-neutralized slurry outputs 116A1-A3 and 116B1-B3 may be in communication with each of circum-neutralized slurry outputs 116A and 116B via individual conduits in some embodiments. The individual particle reactors 110A-C may output sufficiently circum-neutralized CCR slurry through one or both of respective circum-neutralized slurry outputs 116A1-A3 and 116B1-B3. For example, an individual particle reactor 110A-C may output circum-neutralized CCR slurry through a respective individual circum-neutralized slurry output 116A1-A3 when it is desirable and/or necessary to further separate solids from liquids utilizing clarifier 120. Also, for example, an individual particle reactor 110A-C may output circum-neutralized CCR slurry through a respective individual circum-neutralized slurry output 116B1-B3 when it is not desirable and/or necessary to further separate solids from liquids utilizing clarifier 120. Although an acidic waste stream intake 112, a separate CCR intake 114, and separate slurry outputs 116A and 116B are depicted in FIG. 1 and FIG. 2, one of ordinary skill in the art having had the benefit of the present disclosure will recognize and appreciate that one or more of acidic waste stream intake 112, CCR intake 114, and/or separate slurry outputs 116A and 116B may form a single intake/output in some embodiments. For example, in some embodiments they may all be an actuable lid that, when open, enables the receipt of an acidic waste stream 101 and CCR supply 103 and that enables the evacuation of circum-neutralized CCR slurry.

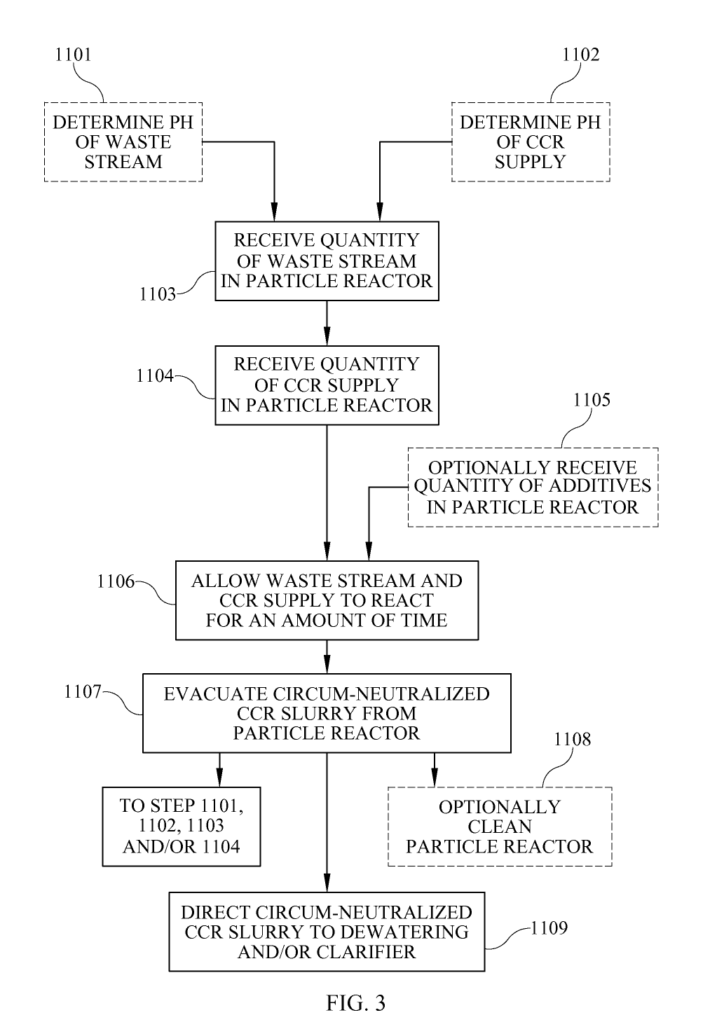

Referring to FIG. 3, an embodiment of a neutralization process utilizing the particle reactor 110 of FIG. 1 and FIG. 2 is illustrated. The steps in the neutralization process of FIG. 3 that are enclosed in dashed lines (e.g., step 1101) indicate that the step is optional and/or may only be performed intermittently in the embodiment of FIG. 3. At step 1101 the pH of a quantity of acidic waste stream 101 is determined. For example, the quantity of acidic waste stream delivered into an individual particle reactor 110A-C may be measured utilizing a pH probe within the individual particle reactor 110A-C. Also, for example, a quantity of acidic waste stream 101 moving through a conduit and/or stored in a temporary storage container upstream of individual particle reactors 110A-C may be measured utilizing a pH probe. The pH probe may optionally be in communication with the controller 180 and provide acidic waste stream pH data thereto. The pH probe may also optionally output the pH data to an operator who may optionally input the data into controller 180 and/or utilize the data to manually perform one or more steps described herein. Also, for example, the pH of the acidic waste stream 101 may be estimated based on, for example, historical data, data related to the source of the acidic waste stream 101, and/or a visual indicator (e.g., pH strip). The controller 180 may estimate such a pH, an operator may estimate or measure such pH and input the data into controller 180, and/or an operator may utilize the estimated pH to manually perform one or more steps described herein. In some embodiments step 1101 may be performed in conjunction with each reaction of a quantity of acidic waste stream 101 and a quantity of CCR supply 103 in an individual particle reactor 110A-C. In other embodiments step 1101 may be omitted, performed with greater frequency, and/or performed with less frequency. For example, in some embodiments step 1101 may be performed at an interval such as, for example, hourly, daily, or weekly.

At step 1102 the pH of a quantity of CCR supply 103 is determined. For example, the quantity of CCR supply 103 delivered into an individual particle reactor 110A-C (empty or filled with a quantity of acidic waste stream 101 and/or other liquid) may be mixed with an aqueous solution of known pH and measured utilizing a pH probe within the individual particle reactor 110A-C. Also, for example, a quantity of CCR supply 103 moving through a conduit, moving on a conveyor, and/or stored in a temporary storage container may be mixed with an aqueous solution of known pH and measured utilizing a pH probe. The quantity of CCR supply 103 may optionally be mixed with a known quantity of liquid of known pH to thereby determine the pH of the CCR supply 103. The pH probe may optionally be in communication with the controller 180 and provide pH data of the CCR supply thereto. The pH probe may also optionally output the CCR pH data to an operator who may optionally input the data into controller 180 and/or utilize the data to manually perform one or more steps described herein. Also, for example, the pH of the CCR supply 103 may be estimated based on, for example, historical data, data related to the source of the CCR supply 103, and/or specific conductivity of the CCR supply 103. The controller 180 may estimate such a pH, an operator may estimate and/or measure such pH and input the data into controller 180, and/or an operator may utilize the estimated pH to manually perform one or more steps described herein. Also, for example, if the CCR supply 103 is provided as CCR slurry, the pH of the CCR slurry may be measured. In some embodiments step 1102 may be performed in conjunction with each reaction of a quantity of acidic waste stream 101 and a quantity of CCR supply 103 in an individual particle reactor 110A-C. In other embodiments step 1102 may be omitted, performed with greater frequency, and/or performed with less frequency. For example, in some embodiments step 1102 may be performed at an interval such as, for example, each shift change, twice a day, or weekly.

At step 1103 a quantity of acidic waste stream 101 is received in an individual particle reactor 110A-C. In some embodiments step 1103 may occur prior to steps 1101 and/or 1102 and/or may occur after steps 1104 and/or 1105. The quantity of acidic waste stream 101 that is received in an individual particle reactor 110A-C may be dependent on, inter alio, the size of the individual particle reactor 110A-C, the pH of the acidic waste stream 101, the quantity of stored acidic waste stream 101, the pH of the CCR supply 103, the quantity of stored CCR supply 103, the composition of the CCR supply 103 (e.g., heavy metals content, physical makeup), and/or the composition of the acidic waste stream 101 (e.g., sulfur-based acids; nitrogen-based acids; carbon-based acids; and/or acidic byproducts of sulfur, nitrogen, and/or carbon). Metering structure may optionally be provided at waste stream intake 112 and/or individual waste stream intakes 112A-C to monitor the quantity of acidic waste stream 101 received in a given individual particle reactor 110A-C.

At step 1104 a quantity of CCR supply 103 is received in an individual particle reactor 110A-C. In some embodiments step 1104 may occur prior to steps 1101, 1102 and/or 1103 and/or may occur after step 1105. The quantity of CCR supply 1103 that is received in an individual particle reactor 110A-C may be dependent on, inter alio, the size of the individual particle reactor 110A-C, the pH of the acidic waste stream 101, the quantity of stored acidic waste stream 101, the pH of the CCR supply 103, the quantity of stored CCR supply 103, the composition of the CCR supply 103 (e.g., heavy metals content, physical makeup), and/or the composition of the acidic waste stream 101 (e.g., sulfur-based acids; nitrogen-based acids; carbon-based acids; and/or acidic byproducts of sulfur, nitrogen, and/or carbon). Metering structure may optionally be provided at CCR supply intake 114 and/or individual CCR supply intakes 114A-C to monitor the quantity of CCR supply 103 received in a given individual particle reactor 110A-C.

At step 1105 a quantity of additives is optionally received in an individual particle reactor 110A-C. The additives may include, for example, reagent(s) that influence the chemical reaction between the quantity of CCR supply 103 and the acidic waste stream 101 and/or pH additives that alter the pH of the circum-neutralized slurry that is produced by such reaction. The additives may be selectively added, intermittently added, periodically added, and/or continuously added. Whether any additives are utilized and, if so, the quantity of additives and type of additives may be dependent on, inter alia, the size of the individual particle reactor 110A-C, the pH of the acidic waste stream 101, the quantity of stored acidic waste stream 101, the pH of the CCR supply 103, the quantity of stored CCR supply 103, the composition of the CCR supply 103 (e.g., heavy metals content, physical makeup), and/or the composition of the acidic waste stream 101 (e.g., sulfur-based acids; nitrogen-based acids; carbon-based acids; and/or acidic byproducts of sulfur, nitrogen, and/or carbon). Whether any additives are utilized and, if so, the quantity of additives and type of additives may be determined by an operator and/or the controller 180 (optionally utilizing input from an operator and/or one or more sensors). Metering structure may optionally be provided to monitor the quantity of additives received in a given individual particle reactor 110A-C.

At step 1106 the received quantity of the CCR supply 103, the acidic waste stream 101, and any additives are allowed to react in one of the individual particle reactors 110A-C for an amount of time. The residence time of the quantity of CCR supply 103 and the quantity of acidic waste stream 101 in a given of individual particle reactors 110A-C may be dependent on a number of factors. For example, in some embodiments they may be allowed to react for a predetermined amount of time. Also, for example, in some embodiments they may be allowed to react for a predetermined amount of time, but the time may be shortened if one or more sensors indicate a substantially circum-neutral pH level has been obtained. Also, for example, in some embodiments they may be allowed to react for a predetermined amount of time, but the time may be lengthened if one or more sensors indicate a substantially circum-neutral pH level has not been obtained at the end of the predetermined amount of time. Also, for example, in some embodiments they may be allowed to react for an amount of time that is determined, in whole or in part, by one or more sensed and/or manually entered data values (e.g., pH of acidic waste stream 101, CCR type, CCR average particle size, CCR particle size distribution). Also, for example, in some embodiments they may be allowed to react until a pH probe indicates that a substantially circum-neutral pH has been obtained. Also, for example, in some embodiments they may be allowed to react until a temperature probe (e.g., thermocouple, temperature dependent resistor) indicates that a predetermined temperature has been substantially obtained. For example, the predetermined temperature may be indicative of a temperature that indicates the exothermic reaction has progressed to a point where the slurry is substantially circum-neutralized. Also, for example, in some embodiments they may be allowed to react until a conductivity probe indicates that a predetermined conductivity of the slurry has been obtained. For example, the predetermined conductivity may be indicative of a temperature value (e.g., micro-Siemens) that indicates the reaction has progressed to a point where the slurry is substantially circum-neutralized. Also, for example, in some embodiments they may be allowed to react until halted by an operator. Also, for example, in some embodiments the viscosity of the CCR slurry may be monitored and utilized as an indicator of whether the slurry is substantially circum-neutralized.

At step 1107 the circum-neutralized CCR slurry that results from the reaction in step 1106 is evacuated from the particle reactor. As described herein, the circum-neutralized CCR slurry may be evacuated through a respective individual circum-neutralized slurry output 116A1-A3 when it is desirable and/or necessary to further separate solids from liquids utilizing clarifier 120. Also, for example, the circum-neutralized CCR slurry may be evacuated through a respective individual circum-neutralized slurry output 116B1-B3 when it is not desirable and/or necessary to further separate solids from liquids utilizing clarifier 120. The circum-neutralized CCR slurry may be evacuated into piping or other conduit in some embodiments, a transportable temporary storage container in some embodiments, or directly into dewatering structure 130 and/or a clarifier 120 in some embodiments. In some embodiments the evacuation may be automated by the controller 180 (e.g., by causing the opening of a valve, a door, or other actuable structure) following completion of step 1106. In some embodiments the evacuation may be performed by an operator, optionally after notification by a notification device in communication with the controller 180. One or more of pumps, scrapers, jets, vibratory equipment, tilting equipment, or other structure may optionally be utilized to facilitate the removal of circum-neutralized CCR slurry from the individual particle reactor 110A-C.

At step 1108 the individual particle reactor 110A-C is optionally cleaned. The individual particle reactor 110A-C may optionally be cleaned utilizing a neutral liquid to wash leftover circum-neutralized CCR slurry from the interior of the individual particle reactor 110A-C. The leftover circum-neutralized CCR slurry and the neutral liquid may optionally be evacuated through one or both of respective circum-neutralized slurry outputs 116A1-A3, 116B1-B3.

At step 1109 the evacuated circum-neutralized CCR slurry is directed to dewatering structure 130 and/or clarifier 120. In some embodiments the circum-neutralized CCR slurry is sent only to dewatering structure 130. In some embodiments the circum-neutralized CCR slurry is sent to clarifier 120, then to dewatering structure 130. In some embodiments the circum-neutralized CCR slurry is sent to both dewatering structure 130 and clarifier 120. For example, a portion of the circum-neutralized CCR slurry from a single batch will be sent to dewatering structure 130 and a portion will be sent to clarifier 120. Also, for example, all of the circum-neutralized CCR slurry from a single batch will be sent to dewatering structure 130 if it has certain characteristics and will be sent to clarifier 120 if it has certain other characteristics.

Following evacuation of the circum-neutralized CCR slurry in step 1107, the circum-neutralization process may repeat by proceeding to steps 1101, 1102, 1103, and/or 1104. The process may proceed to steps 1101, 1102, 1103, and/or 1104 immediately, may wait a predetermined amount of time before proceeding thereto, and/or may wait for one or more automated and/or manual signals before proceeding.

In some embodiments one or more of the individual particle reactors 110A-C may be an optionally modified M80 Low Amplitude Grinding Mill available from SWECO of Florence, KY; Supermill Plus available from Custom Milling and Consulting of Fleetwood, Pa.; and/or a PSM Submersible Basket Mill available from Netzsch Premier Technologies, LLC of Exton, Pa. For example, the reactor may be modified to include a liner having characteristics that enable storage of material having a relatively high temperature, a relatively coarse nature, and/or a relatively corrosive and/or acidic nature. For example, the liner may include ceramic, a corrosion-resistant metal and/or metal alloy (e.g., carbon steel, stainlees steel, titanium, hastelloy), a corrosion-resistant polymer (e.g., ABS, ECTFE, PVDF, PVC, CPVC, polypropylene, ryton, Teflon, UHMW polymers, cross-linked polymers), corrosion-resistant elastomers (e.g., Viton, EPDM, hypalon, neoprene, nitrile). Also, for example, the reactor may be modified to include a super cooled vessel jacketing, a heat exchanger, and/or CCR slurry recirculation system.

Referring again to FIG. 1, circum-neutralized CCR slurry that is evacuated through circum-neutralized slurry output 116B is directed to a circum-neutralized CCR slurry input 123 of clarifier 120. Generally, clarifier 120 separates solids such as the circum-neutralized CCR from liquids such as the circum-neutralized water effluent. Some or all of the circum-neutralized CCR slurry may be directed to the clarifier 120. It may be desirable to direct circum-neutralized CCR slurry to the clarifier 120 when the amount of solids loading is relatively low such as, for example, when the alkalinity of the CCR supply 103 is relatively high and the amount thereof needed to circum-neutralize the acidic waste stream 101 is therefore relatively low. In some embodiments the more aqueous portion of the circum-neutralized CCR slurry will be directed to clarifier 120 and the more solids loaded portion will be directed toward the dewatering structure 130. Whether some or all of the circum-neutralized CCR slurry is directed to the clarifier 120 may be determined by, for example, visual inspection by an operator, optical sensor(s) measuring the solids loading of the CCR slurry, and/or sensor(s) (e.g., viscometers and/or rheometers) measuring the viscosity of the CCR slurry. In some embodiments of the treatment system 100 the clarifier 120 is omitted.

The clarifier 120 may include one or more of a settling tank, a gravity precipitator, a centrifuge, and/or mechanical screening to facilitate the separation of solids and liquids. Optionally, one or more additives 121 may be added to the clarifier 120 via additive input 121A thereof. In some embodiments the additives may be additionally or alternatively added at slurry input 123 and/or to circum-neutralized CCR slurry upstream of clarifier 120. The additives 121 may include, for example, polymers, coagulants, and/or thickening agents that may facilitate the clarification process.

The amount of time the circum-neutralized CCR slurry is in the clarifier 120 may be dependent on a number of factors. For example, in some embodiments the amount of time the circum-neutralized slurry is in the clarifier 120 may be dependent on the makeup of the circum-neutralized CCR slurry and/or the configuration of the clarifier 120. Also, for example, in some embodiments an operator may optionally visually check the clarifier 120 to determine when the circum-neutralized CCR and the circum-neutralized water effluent have been sufficiently separated. Also, for example, one or more sensors may additionally or alternatively be utilized to make such a determination. For example, one or more optical sensors may be directed across portions of the solution within the clarifier 120 and communicate readings to the controller 180 to determine the relative solids and liquid content thereof. Also, for example, in some embodiments the circum-neutralized CCR slurry may be left in the clarifier 120 for a predetermined amount of time. The predetermined amount of time may optionally be dependent on one or more sensed and/or manually entered data values. Also, for example, in some embodiments the circum-neutralized CCR slurry may be left in the clarifier 120 for a predetermined amount of time, but the time may be shortened if one or more sensors indicate a sufficient level of separation has been obtained. Also, for example, in some embodiments the circum-neutralized CCR slurry may be left in the clarifier 120 for a predetermined amount of time, but the time may be lengthened if one or more sensors indicate a sufficient level of separation has not been obtained at the end of the predetermined amount of time.

Circum-neutralized water effluent that is sufficiently separated from the circum-neutralized CCR slurry by clarifier 120 may be output through circum-neutralized water effluent output 124 and directed to a circum-neutralized water effluent input 152B of water effluent remediation structure 150. Circum-neutralized CCR slurry may be output through circum-neutralized CCR slurry output 126 toward a circum-neutralized CCR slurry input 133B of dewatering structure 130. The evacuated circum-neutralized water effluent may be communicated to water effluent remediation structure 150 and/or the evacuated circum-neutralized CCR slurry may be communicated to dewatering structure 130 utilizing, for example, one or more of the methods and/or apparatus described herein (e.g., conduit, conveyor belts, channels, storage containers, vehicles, pumps). Generally speaking, water effluent remediation structure 150 alters the state of one or more heavy metals from the circum-neutralized water effluent. For example, the water effluent remediation structure 150 may alter the valence state of one or more heavy metals. Also, for example, the water effluent remediation structure 150 may remove one or more heavy metals.

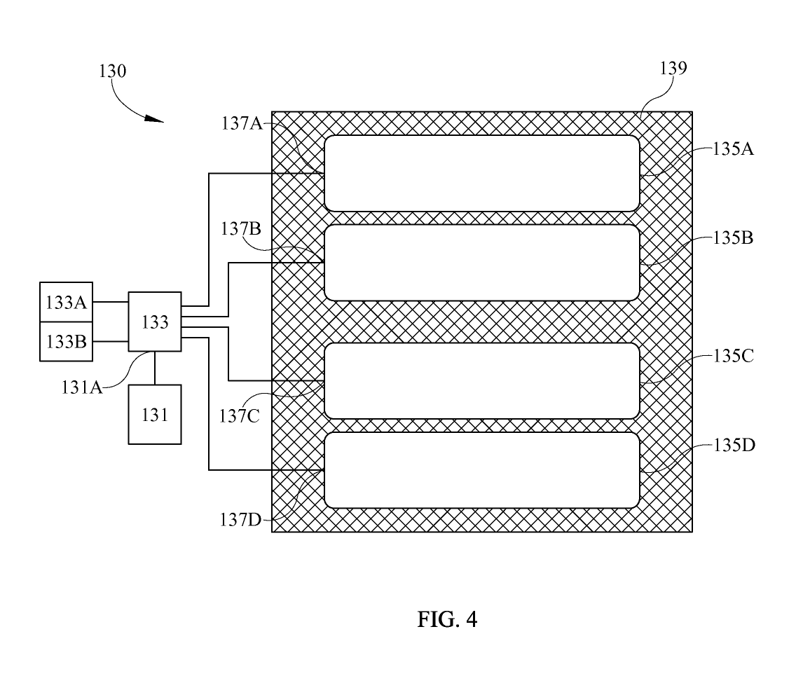

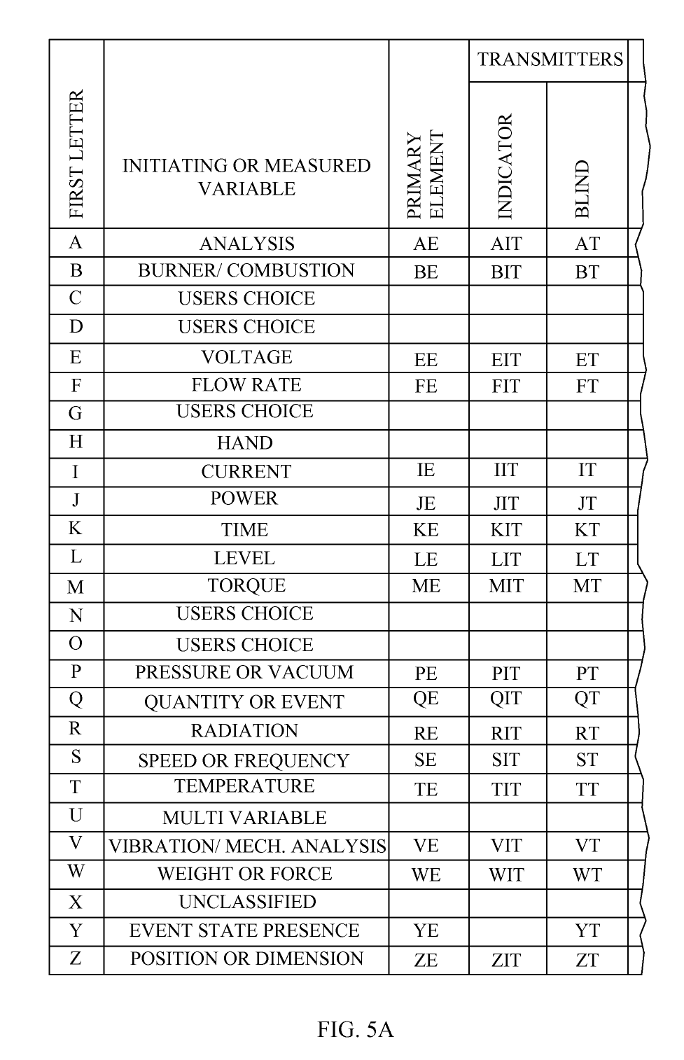

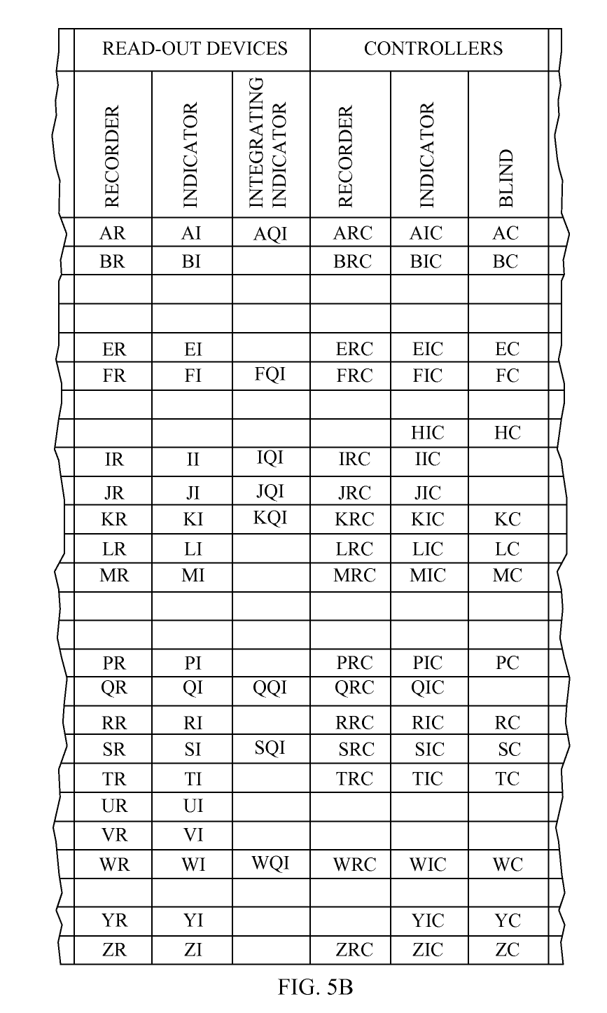

Circum-neutralized CCR slurry from particle reactor 110 and/or from clarifier 120 is directed to respective circum-neutralized CCR slurry inputs 133A and/or 133B of dewatering structure 130. Generally speaking, dewatering structure 130 removes a quantity of liquid from the circum-neutralized CCR slurry to thereby produce substantially stable circum-neutral CCR cake 140. Referring to FIG. 4, a schematic view showing an embodiment of the dewatering structure 130 is illustrated. The dewatering structure 130 includes a slurry input valve 133 that is fed by slurry inputs 133A and 133B. In alternative embodiments fewer or more inputs may be provided. The slurry input valve 133 selectively feeds inputs 137A-D of four separate porous dewatering tubes 135A-D. The slurry input valve 133 may be manually actuable and/or automatically actuable. For example, in some embodiments the slurry input valve 133 may be automatically actuable, its status being dictated by a controller. The controller may cause the status to be altered, for example, after a predetermined amount of time, after metering structure indicates a predetermined amount of circum-neutralized CCR slurry has flowed into a dewatering tube 135A-D, after a weight sensor indicates a predetermined weight of circum-neutralized CCR slurry has flowed into dewatering tube 135A-D, after an optical sensor indicates that a dewatering tube has expanded beyond a predetermined location, and/or after manual observation indicates completion of the filling of a dewatering tube 135A-D.

The dewatering tubes 135A-D may be made from heavy duty permeable fabric/membrane that traps solids and allows water to escape. In some embodiments the dewatering tubes 135A-D may be GEOTUBES available from TenCate Industrial Fabrics North America of Pendergrass, Georgia. The dewatering tubes 135A-D are placed atop a grating 139 that enables circum-neutralized water effluent that escapes from the dewatering tubes 135A-D to pass therethrough. The circum-neutralized water effluent may be collected underneath the grating 139 and directed through a circum-neutralized water effluent output 134 (FIG. 1) to a circum-neutralized water effluent input 152A of water effluent remediation structure 150. In alternative embodiments the dewatering tubes 135A-D may be placed on alternative structure such as, for example, a concrete sump, concrete risers, and/or a sludge drying bed. Circum-neutralized water effluent may optionally be collected in some of those embodiments. In alternative embodiments more or fewer dewatering tubes 135A-D may be provided. For example, a single individual dewatering tube may be provided in some embodiments. Also, for example, more individual dewatering tubes may be provided in some embodiments to increase capacity and/or to provide redundancy. In some embodiments the dewatering tubes 135A-D may be filled and then transported to another location. In some embodiments a single conduit may be utilized to fill multiple dewatering tubes 135A-D. In some versions of those embodiments the single conduit may be the only conduit provided between inputs 133A and/or 133B and the dewatering tubes 135A-D.

Optionally, one or more additives 131 may be added to the dewatering structure 130 via additive input 131A thereof, which is in communication with slurry input 133. In some embodiments the additives may be additionally or alternatively added elsewhere such as, for example, at inputs 137A-D, slurry inputs 133A and/or 133B, and/or to circum-neutralized CCR slurry upstream of dewatering structure 130. The additives may include, for example, polymers, coagulants, and/or thickening agents that may aid or help facilitate the dewatering process.

In some embodiments the slurry input valve 133 may feed a single one of dewatering tubes 135A-D until full and then be diverted to feed another single one of dewatering tubes 135A-D until full. In some versions of these embodiments the dewatering tubes 135A-D may be marked and tracked. This may enable analysis of the characteristics of the resulting dried substantially stabilized circum-neutral CCR cake, thereby providing insight into acidic waste stream 101 characteristics, CCR supply 103 characteristics, reaction characteristics, clarification characteristics, and/or other data during a period of time. Alternatively, the slurry input valve 133 may feed multiple dewatering tubes 135A-D simultaneously. Optionally, after a dewatering tube 135A-D has been filled, then had time to leach out an amount of water from the circum-neutralized CCR slurry, that dewatering tube 135A-D may have excess room, thereby enabling that dewatering tube 135A-D to be filled with additional CCR slurry.

In alternative embodiments the dewatering structure 130 may additionally or alternatively include other structure. For example, the dewatering structure may additionally or alternatively include one or more centrifuges, screw presses, belt presses, filter presses, sieves, rotary vacuums, and/or horizontal vacuums. One or more of such structures may optionally be provided upstream or downstream of other of such structures and/or of the GEOTUBES described with respect to FIG. 4. Land farming and/or drying beds may also additionally or alternatively be utilized.

After a sufficient amount of circum-neutralized water effluent has been removed from the circum-neutralized CCR slurry fed into the dewatering tubes 135A, substantially stabilized circum-neutral CCR cake is left within the dewatering tubes 135A. In some embodiments the substantially stabilized circum-neutral CCR cake within the dewatering tubes 135A may have a water content of approximately 25% to 60%. In some embodiments the substantially stabilized circum-neutral CCR cake within the dewatering tubes 135A may have a water content of approximately 15% to 40%. In some embodiments such as, for example, those that may additionally or alternatively use other dewatering structure, lower percentages of water content may be achieved.

The substantially stabilized circum-neutral CCR cake that results from the dewatering 130 is then sent to solids handling structure 145. The solids handling structure may include, for example, a conveyor, a hopper, a dumpster, a vehicle, a skid loader, heavy equipment, a train, and/or other transportation and/or handling structure. For example, in some embodiments the dewatering tubes 135A may be sized to fit on a train car and may be transported to the train car utilizing heavy equipment such as a crane. Also, for example, in some embodiments substantially stabilized circum-neutral CCR cake is fed from a belt press onto a conveyor belt, which in turn transfers the cake to a hopper for further transport.

The substantially stabilized circum-neutral CCR cake 140 may be utilized in one or more secondary uses. For example, the substantially stabilized circum-neutral CCR cake 140 may be utilized in Portland cement, as structural fill, as backfill material, bricks, mineral for asphalt pavement, paints, plastics, soil amendments for crops, countertops, vinyl flooring, synthetic lumber, siding, shingles, tiles, wall board, and/or pipes. In some embodiments the substantially stabilized circum-neutral CCR cake 140 may have characteristics that enable it to pass the Toxicity Characteristic Leaching Procedure (TCLP) test.

Referring again to FIG. 1, the circum-neutralized water effluent that is directed to circum-neutralized water effluent inputs 152A and/or 152B is additionally remediated by water effluent remediation structure 150. The water effluent remediation structure 150 may include, inter alio, one or more clarifying units. Clarifying units include clarifiers, chemical induced heavy metal precipitators, and filter units.

Any clarifier may include one or more of, for example, a settling tank, a gravity precipitator, a centrifuge, and/or a mechanical screening to facilitate the separation of solids and liquids. Optionally, one or more additives 151 may be added to the remediation structure 150 via additive input 151A thereof. In some embodiments the additives 151 may be additionally or alternatively be added at inputs 152A and/or 152B, other inputs, and/or to circum-neutralized water effluent upstream of the remediation structure 150. The additives 151 may include, for example, polymers, coagulants, and/or thickening agents that may facilitate the clarification process.

Any chemical induced heavy metal precipitator included in remediation structure 150 may utilize one or more additives 151 added thereto via additive input 151A or elsewhere to facilitate precipitation of one or more heavy metals. For example, oxidants and/or reductants may be utilized as additives 151 to precipitate out one or more heavy metals. Optionally, the oxidant(s) and/or reductant(s) may be separately added. For example, an oxidant may first be utilized to precipitate out any arsenic present in the circum-neutralized water effluent and a reductant may then be utilized to precipitate out any chromium present in the circum-neutralized water effluent.

Any filter unit included in remediation structure may include one or more of, for example, a bag filter, a cartridge filter, a membrane, a reverse osmosis unit, an ultra pure filtration unit, a nano pure water treatment system, a sieve, and/or a segregator. One or more additives 151 may be added to any filter unit via additive input 151A or elsewhere to facilitate filtering of one or more solids. The additives may include, for example, polymers, coagulants, and/or thickening agents that may facilitate the clarification process. Also, one or more additives 151 may be supplied to the remediation structure 150 to further alter the pH of the water effluent as desired.

Any precipitated solids 160 from the remediation structure 150 may be collected and disposed of properly. For example, the precipitated solids may be collected in drums or other containers and disposed of in accordance with appropriate governmental guidelines.

Remediated circum-neutralized water effluent is output from remediation structure 150 through remediated circum-neutralized water effluent output 154 into a treated water discharge 155. In some embodiments the treated water discharge 155 may include one or more of a sanitary or storm sewer or a surficial water body. In some embodiments the treated water discharge 155 may include piping or other transportation that leads to utilization of the water in one or more aspect of the treatment system 100 or other upstream process(es). For example, in some embodiments the remediated circum-neutralized water effluent may be fed back into the scrubber, venturi scrubber, and/or other pollution abatement system that produces the acidic waste stream 101, for use therein. Also, for example, in some embodiments the remediated circum-neutralized water effluent may be fed back into CCR supply 103 to help dilute a dense CCR supply 103. Also, for example, in some embodiments the remediated circum-neutralized water effluent may be utilized to clean particle reactor 110. In some embodiments the remediated circum-neutralized water effluent may have characteristics that enable it to obtain a National Pollutant Discharge Elimination System (NPDES) permitting.

In alternative embodiments one or more sensors may be provided prior to discharge of remediated circum-neutralized water effluent into treated water discharge 155. For example, one or more sensors may be provided that measure the pH, heavy metal content, and/or other solids content of the remediated circum-neutralized water effluent. If the sensors indicate the remediated circum-neutralized water effluent is unsatisfactory for discharge into treated water discharge 155, the remediated circum-neutralized water effluent may be fed into the treatment system 100 at one or more locations. For example, in some embodiments the remediated circum-neutralized water effluent may be fed back into the water effluent remediation structure 150 for further remediation thereof. Also, for example, in some embodiments the remediated circum-neutralized water effluent may be fed back into CCR supply 103 to help dilute a dense CCR supply 103. Also, in some embodiments the remediated circum-neutralized water effluent may be fed back into the scrubber, venturi scrubber, and/or other pollution abatement system that produces the acidic waste stream 101, for use therein.

Referring now to FIGS. 5A-29, various aspects of a second embodiment of a treatment system 2100 are shown. FIGS. 14-28 provide detailed schematics of the treatment system 2100. FIG. 29 provides an overview of certain aspects of the treatment system 2100 of the schematics of FIGS. 14 through 28 and is provided for ease in viewing interaction between certain components of the treatment system 2100. FIGS. 5A-13 provide a guide for symbols, abbreviations, and designations that may be utilized throughout the detailed schematics of FIGS. 14-28. In the interest of conciseness, only certain of the various components of the treatment system 2100 are described and called out with a specific reference number herein. Other components of the treatment system 2100 may be described in this detailed description, but not pointed out with a specific reference number. Yet other components, and details of certain components, may not be described in this detailed description or pointed out with a specific reference number, but are illustrated and/or described in one or more Figures. One of ordinary skill in the art, having had the benefit of the present disclosure, will be able to reference such Figures to ascertain positioning, structure, and/or functionality of such components.

Also, although specific detail regarding the treatment system 2100 is provided throughout FIGS. 5A-29 and this detailed description, one of ordinary skill in the art, having had the benefit of the present disclosure, will recognize and appreciate that various components may optionally have different properties, may be replaced with other components, may feed one or more different downstream components, may be fed from one or more different upstream components, and/or may be removed from the treatment system 2100. For example, certain component sizes, materials, and/or quantities may be configured for a particular implementation of the treatment system 2100. For example, listed piping size and piping material may be selected based upon throughput requirements, cost considerations, and/or heat requirements. Also, for example, certain redundancy components may be removed from and/or added to the treatment system 2100 in certain implementations.

Moreover, one of ordinary skill in the art, having had the benefit of the present disclosure, will recognize and appreciate that various aspects of the treatment system 2100 may be implemented independent of other aspects of the treatment system 2100. For example, certain particle reactor(s) of the system, reaction process(es), CCR feeding structure(s), milling process(es), CCR feeding process(es), dewatering process(es), dewatering structure(s), heavy metals removal, treated water recirculation process(es), treated water recirculation system(s), instrumentation of the system, sensors of the system, monitoring of the system, and/or other structural aspects of and/or methods related to a treatment system 2100 may be implemented independent of other aspects of the treatment system 2100. For example, one or more aspects of the CCR feeding processes may be implemented independent of any other aspect of the treatment system 2100 in some embodiments. Also, for example, one or more aspects of the treated water recirculation processes and/or structures may be implemented independent of any other aspect of the treatment system 2100 in some embodiments. Therefore, one of ordinary skill in the art, having had the benefit of the present disclosure, will recognize and appreciate that the schematics depicted in FIGS. 14-29 depict an exemplary embodiment only, and is not limiting as to the particular configuration of a treatment system and/or the particular configuration of one or more aspects of a treatment system.

Referring initially to FIGS. 14 and 15, an aqueous stream 2101 feeds into piping that directs the aqueous stream 2101 to a downstream tank 2184. A pump 2175a may be utilized to assist in transportation of the aqueous stream 2101 to the tank 2184. Although specific piping and pumps are illustrated throughout FIGS. 14-28, one of ordinary skill in the art, having had the benefit of the present disclosure, will recognize and appreciate that material(s) may alternatively be delivered through a different series of pipes, pumps, valves, and/or other devices. Such devices may optionally control one or more factors such as, for example, flow rate, temperature, and/or pressure of delivered materials(s). As described herein, the aqueous stream 2101 may be acidic, basic, or neutral. Moreover, the aqueous stream 2101 may be derived from a variety of sources such as, for example, liquid utilized in a pollution abatement system, liquid from a municipal supply, and/or liquid utilized in market sectors such as, for example, pulp and paper, printing, chemicals and allied products, plastics, rubbers, metal industries, drug manufacturing, sewage treatment, steel, textile, production, electronics, and/or petroleum refining. The aqueous stream may optionally include one or more organic and/or inorganic contaminants such as metals, sulfates, nitrates, and/or pesticides. In some embodiments the aqueous stream 2101 may be an acidic waste stream originating from a pollution abatement system treating flue gas emitted from a power plant. In some embodiments the aqueous stream 2101 may have a pH of approximately 1 to 4.75. In some versions of those embodiments the aqueous stream 2101 may have a pH of approximately 1 to 3. In some embodiments the aqueous stream 2101 may be a stream that is provided solely for treating the CCR supply (e.g., to assist in removing heavy metals from the CCR supply). For example, in some embodiments the aqueous stream 2101 may be from a municipal water supply.

In some embodiments the tank 2184 may be a double-walled vessel. In some embodiments the tank 2184 may have a capacity of approximately 5,000 gallons and/or be configured for receipt and storage of an acidic aqueous stream 2101. The tank 2184 may include a high tank level sensor and/or a low tank level sensor. One or more valves may be actuated to alter the flow of the aqueous stream 2101 into and/or out of the tank 2184 based on output from one or more of such sensors. For example, in some embodiments if the sensors indicate a high tank, the flow out of the tank 2184 may be increased and/or the flow into the tank 2184 may be decreased. Also, for example, in some embodiments if the sensors indicate a high tank, at least portions of the aqueous stream 2101 may be diverted to an emergency overflow holding pond 2185 prior to reaching the tank 2184. The emergency overflow holding pond 2185 may optionally include a concrete bottom and/or polymer sheeted sidewalls. Any of aqueous stream 2101 that is stored in the emergency overflow holding pond 2185 may optionally be fed back into the treatment system 2100 at a later time, otherwise treated, and/or otherwise disposed of.

The tank 2184 may also include a pressure sensor and/or temperature sensor. One or more valves may be actuated to alter the flow of the aqueous stream 2101 into and/or out of the tank 2184 based on output from one or more of such sensors. For example, in some embodiments if the sensors indicate an unsafe pressure and/or temperature, the flow into the tank 2184 may be decreased and/or at least portions of the aqueous stream 2101 may be diverted to the emergency overflow holding pond 2185. Also, for example, in some embodiments so long as the tank level is within a safe range, the aqueous stream 2101 may only be allowed to flow out of the tank 2184 when it is within a certain temperature range (e.g., a range that is ideal for downstream processes and/or a range that is ideal for downstream components).

A backup pump 2175ab may optionally be provided in a parallel configuration with pump 2175a in case problems occur with pump 2175a and/or piping adjacent thereto that is not shared with backup pump 2175ab. Pressure sensor 2180 downstream of pump 2175a may be utilized to determine whether a problem with pump 2175a and/or piping adjacent thereto is present. Likewise, pressure sensor 2180b downstream of pump 2175ab may be utilized to determine whether a problem with pump 2175ab and/or piping adjacent thereto is present. A heat exchanger 2182 may also optionally be provided upstream of the tank 2184 to cool the aqueous stream 2101. The heat exchanger 2182 may be in communication with a cooling tower 2183 storing a supply of water. The cooling tower 2183 directs stored water over the inner shell of the heat exchanger 2182, optionally via pump 2175b, that is then recirculated back into the cooling tower 2183. In other embodiments alternative heat exchangers may additionally and/or alternatively be utilized. For example, in some embodiments heat exchangers may be utilized that enable capture and re-use of heat for secondary purposes. In some embodiments it may not be desirable to cool the aqueous stream 2101 utilizing a heat exchanger. In some versions of those embodiments it may be desirable to heat the aqueous stream 2101.

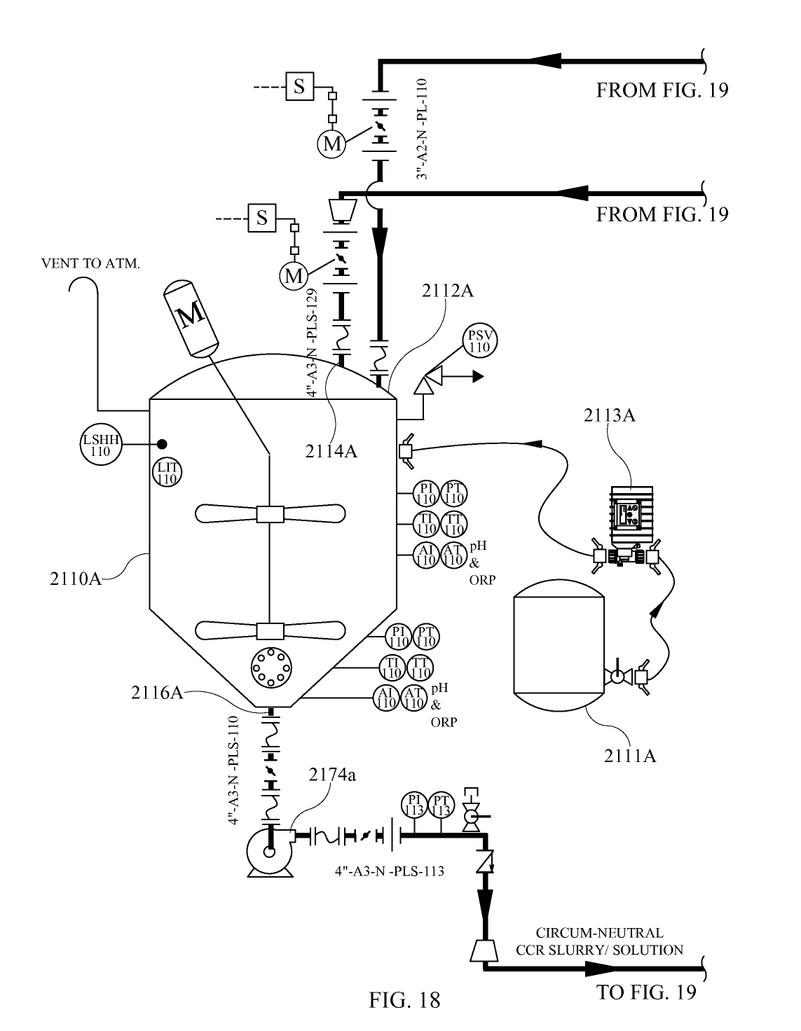

With continuing reference to FIGS. 14 and 15, and additional reference to FIGS. 18-20, in some embodiments it may be desirable for the aqueous stream 2101 to be within a certain temperature range prior to being reacted within particle reactors 2110A-C (FIGS. 18-20). For example, certain elevated temperatures may facilitate a quicker and/or more complete reaction due to, for example, increased system enthalpy and/or the solubility of sparingly soluble compounds in the CCR being increased due to the elevated temperature. A quicker and/or more complete reaction may enable smaller sizes and/or numbers of particle reactors 2110A-C to handle the incoming aqueous stream 2101, may require less CCR supply 2103 for the reaction, and/or may enable a more predictable reaction time.

In some embodiments the aqueous stream 2101 as it is fed to the particle reactors 2110A-C may be between approximately 55° F. and 212° F. In some versions of those embodiments the aqueous stream 2101 as it is fed to the particle reactors 2110A-C may be between approximately 75° F. and 140° F. In some embodiments it may be desirable to utilize the heat exchanger 2182 when the aqueous stream 2101 upstream of heat exchanger 2182 is greater than a certain temperature. For example, in some embodiments it may be desirable to utilize the heat exchanger 2182 when the aqueous stream 2101 upstream of heat exchanger 2182 is greater than approximately 135° F. In some embodiments it may be desirable to increase the temperature of the aqueous stream 2101 when the aqueous stream 2101 is less than a certain temperature. For example, in some embodiments it may be desirable to increase the temperature of the aqueous stream 2101 when the aqueous stream 2101 is less than approximately 90° F. In some embodiments temperature sensor 2181 or 2181b may be utilized, optionally by a controller, to determine whether the optional heat exchanger 2182 should be utilized. In other embodiments the heat exchanger 2182 may optionally be provided downstream of the tank 2184, but upstream of the particle reactors 2110A-C.

The tank 2184 has an outlet that feeds into piping that directs the aqueous stream 2101 to one or more of aqueous stream intakes 2112A-C of particle reactors 2110A-C. A motor is illustrated coupled to a valve upstream of each of aqueous stream intakes 2112A-C and may be selectively actuated to only feed the aqueous stream 2101 to selected one or more of the particle reactors 2110A-C. For example, only a single of the particle reactors 2110A-C may be fed with aqueous stream 2101 at one time in some embodiments. The motor may be controlled via a switch in electrical communication with a controller in some embodiments. A pump 2175c may be utilized to assist in transportation of the aqueous stream 2101 from the tank 2184 to one or more of particle reactors 2110A-C. A backup pump 2175cb may optionally be provided in a parallel configuration with pump 2175c in case problems occur with pump 2175c and/or piping adjacent thereto that is not shared with backup pump 2175cb.

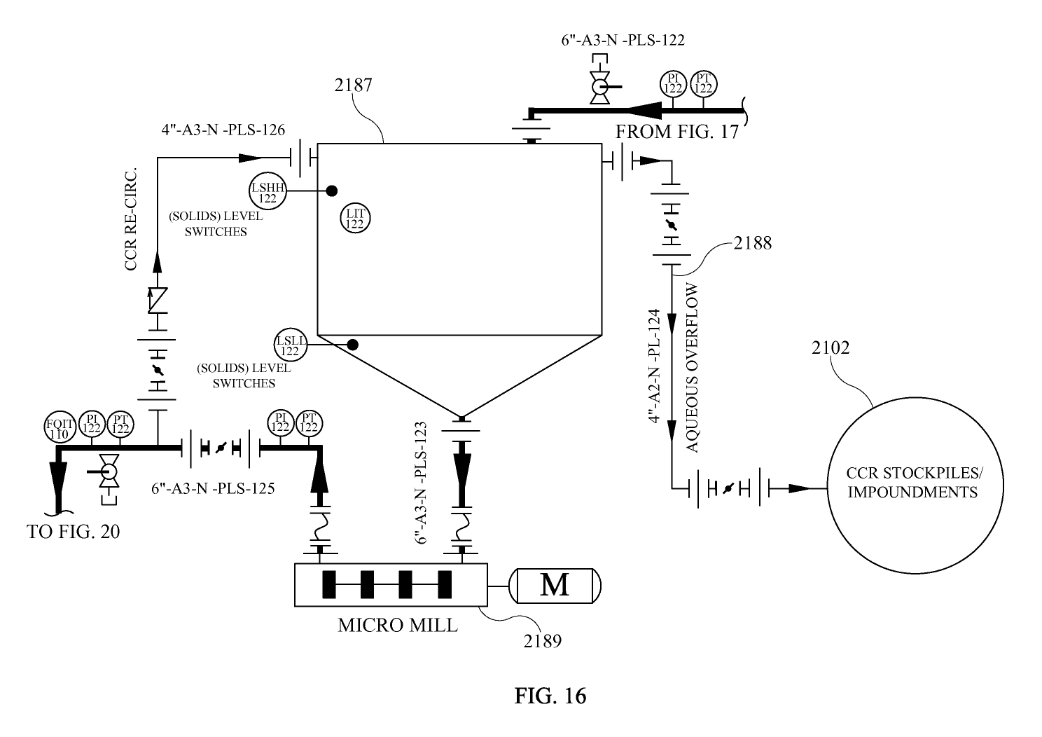

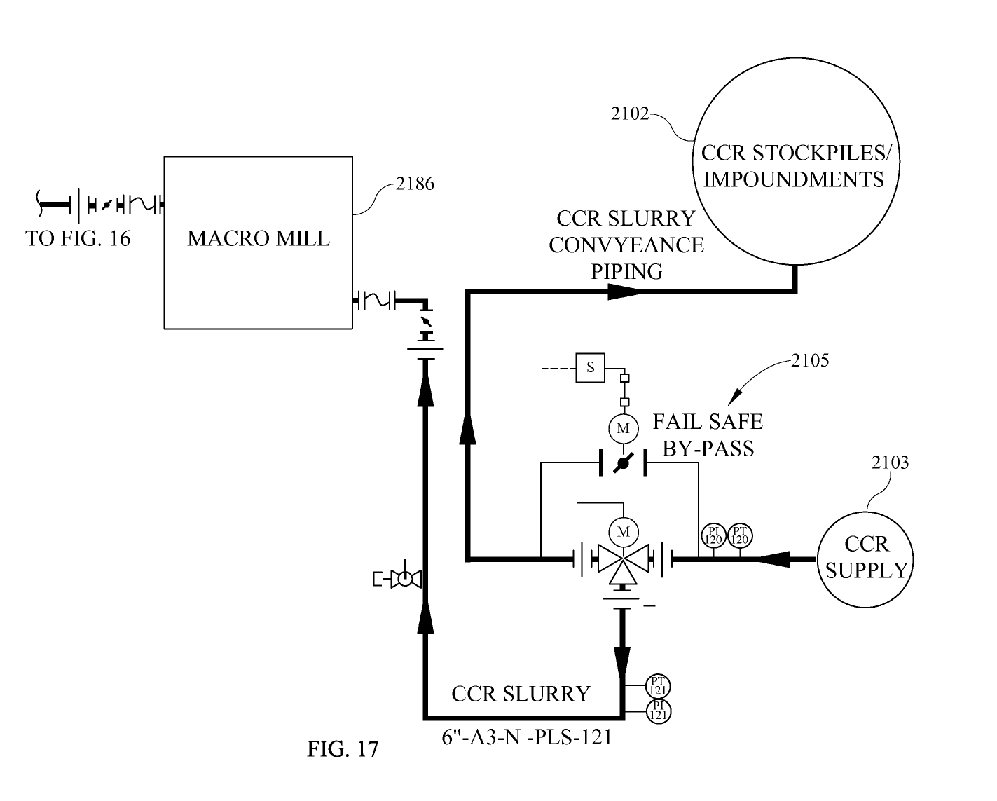

Turning now to FIGS. 16 and 17, a CCR slurry supply 2103 feeds into three-way valve structure having one output leading to a CCR stockpile/impoundment 2102 and another output leading to a macro mill 2186. The CCR slurry supply 2103 may be a CCR slurry output from a coal fired power plant in some embodiments. For example, in some embodiments the CCR slurry supply 2103 may be derived, in whole or in part, from a pumped output of a coal-fired power plant (e.g., an eductor-jet CCR slurry output). Also, for example, in some embodiments the CCR slurry supply 2103 may be derived, in whole or in part, from a CCR slurry stockpile at a coal-fired power plant. In other embodiments the CCR supply may be in non-slurry form and/or may be derived from sources other than a coal-fired powered plant. In some embodiments the CCR supply 2103 may have a pH of approximately 9 to 14. In some versions of those embodiments the CCR slurry supply 2103 may have a pH of approximately 11 to 12. In some embodiments the CCR slurry supply 2103 may have a solids loading percentage (solids to liquid ratio) that is less than or equal to approximately 80%. In some versions of those embodiments the CCR slurry supply 2103 may have a solids loading percentage of approximately 20% to 80%. In some versions of those embodiments the CCR slurry supply 2103 may have a solids loading percentage of less than or equal to approximately 68% without surfactant. In some versions of those embodiments the CCR slurry supply 2103 may have a solids loading percentage of approximately 68% to 80%. In some versions of those embodiments a surfactant may be added to the CCR slurry supply 2103. Solids loading percentages of the CCR supply 2103 from approximately 20% to 68% and/or from approximately 68-80% (with surfactant) may provide desired flow characteristics of the CCR slurry supply 2103 while maintaining desired flow rates through the treatment system. In some embodiments the CCR slurry supply 2103 may be delivered with a desired solids loading percentage (e.g., when delivered from an eductor-jet CCR slurry output of a coal-fired power plant). In some other embodiments water (e.g., treated water from the treatment system and/or water from a municipal supply) may be added to the CCR slurry supply 2103 to achieve a desired solids loading percentage.

An optional bypass 2105 is provided around the three way valve structure and leads to the CCR stockpile/impoundment 2102. The CCR stockpile/impoundment 2102 may include one or more alternative CCR containment structures and/or methodologies. For example, the CCR stockpile/impoundment 2102 may include one or more ash ponds and/or landfills. In some embodiments the macro mill 2186 may mill CCR fed thereto to approximately 300 to 500 microns. It is understood that in those embodiments some CCR fed thereto may be milled to a larger or smaller size and/or that some CCR fed thereto may already be smaller than approximately 300 microns. In some embodiments the macro mill 2186 may be a horizontal media mill available from Custom Milling and Consulting of Fleetwood, Pa.

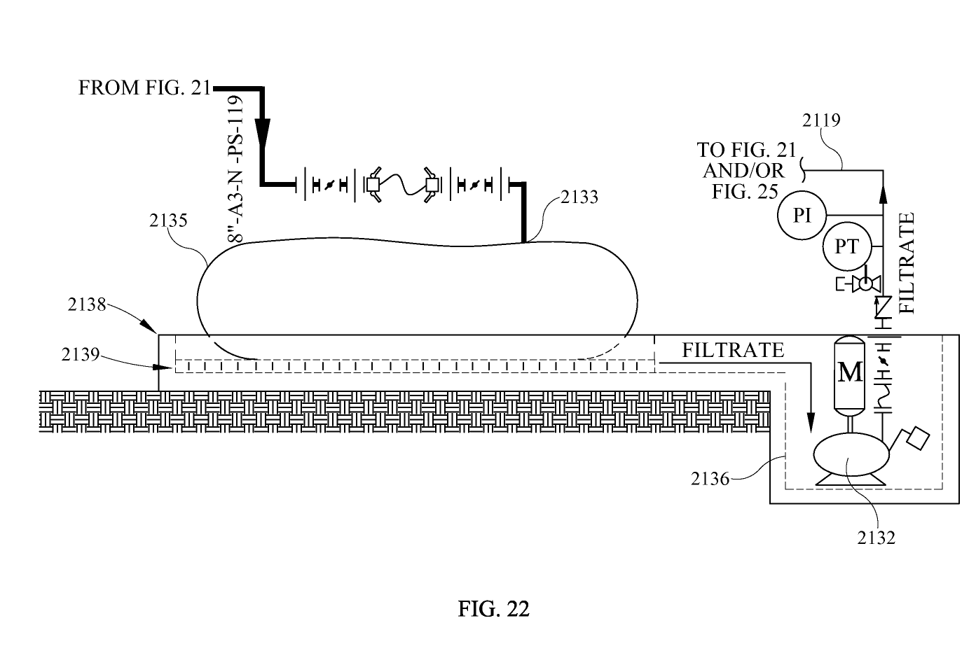

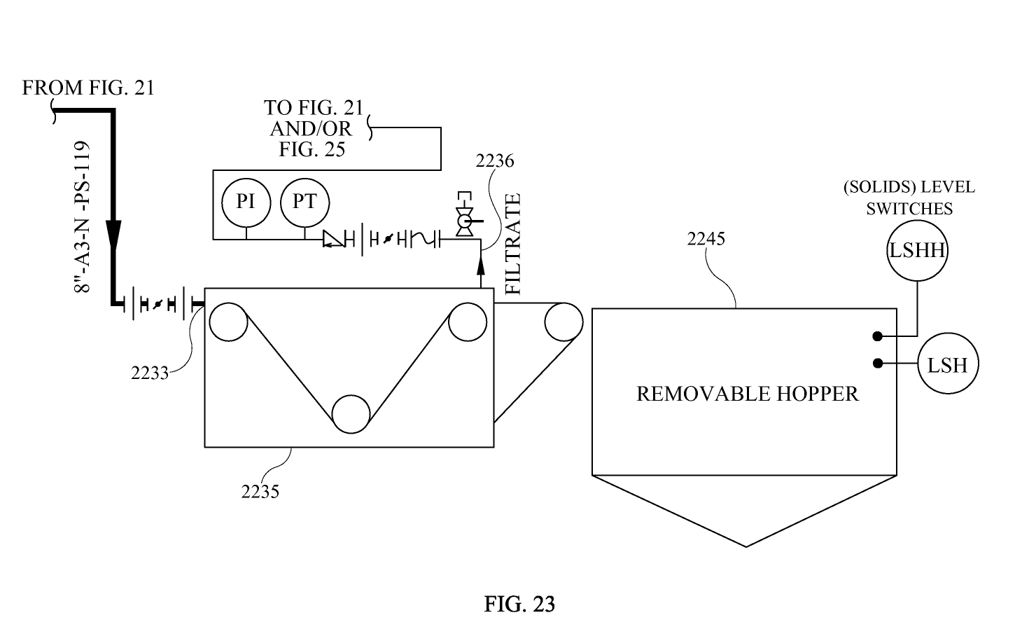

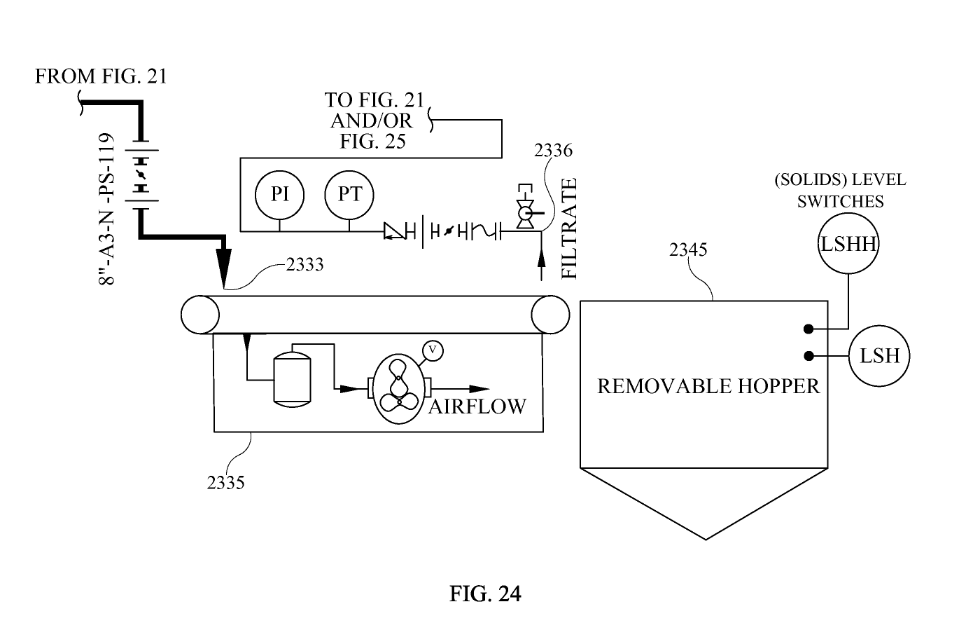

The macro mill 2186 has an output that feeds a bin hopper 2187. The bin hopper 2187 includes an aqueous overflow 2188 that feeds into the CCR stockpile/impoundment 2102. In alternative embodiments the aqueous overflow 2188 may additionally or alternatively feed into the clarifier 2120 (FIG. 21). The bin hopper 2187 also includes an output that feeds into a micro mill 2189. In some embodiments the micro mill 2189 may mill CCR fed thereto to approximately 10 to 50 microns. It is understood that in those embodiments some CCR fed thereto may be milled to a larger or smaller size and/or that some CCR fed thereto may already be smaller than approximately 10 microns. In some embodiments the micro mill 2189 may be a horizontal media mill available from Custom Milling and Consulting of Fleetwood, Pa. The bin hopper 2187 may include a high tank level sensor and/or a low tank level sensor. One or more valves may optionally be actuated to alter the flow of CCR slurry supply 2103 into and/or out of the bin hopper 2187 based on output from one or more of such sensors. For example, in some embodiments if the sensors indicate a high tank, the flow out of the macro mill 2186 may be decreased and/or the three way valve may divert CCR slurry supply 2103 to CCR stockpile/impoundment 2102 for a period of time (e.g., until the sensors no longer indicate a high tank, until the greater of a predetermined period of time and until the sensors no longer indicate a high tank, or until an operator directs the CCR slurry supply 2103 to be redirected back to the bin hopper 2187). In some embodiments the bin hopper 2187 may be approximately 8,500 gallons and/or have an approximately 30° hopper outlet. In some embodiments the CCR slurry supply 2103 that moves through the macro mill 2186, the bin hopper 2187, and/or the micro mill 2189 may have a solids loading percentage that is less than or equal to approximately 80%. In some versions of those embodiments the CCR slurry supply 2103 may have a solids loading percentage of approximately 20% to 80%. In some versions of those embodiments the CCR slurry supply 2103 may have a solids loading percentage of less than or equal to approximately 68% without surfactant. In some embodiments the CCR slurry supply 2103 that moves through the macro mill 2186, the bin hopper 2187, and/or the micro mill 2189 (and to the particle reactors 2110A-C) may have a solids loading percentage of approximately 68% to 80%. In some versions of those embodiments a surfactant may be added to the CCR slurry supply 2103.

In some embodiments the CCR slurry supply 2103 and/or other CCR supply may be sieved (utilizing e.g., a mechanical vibratory sieve) or otherwise sorted to separate out one or more groupings of CCR sizes. For example, in some embodiments sieving may be performed upstream of macro mill 2186 to separate any CCR supply 2103 that is less than approximately 300 microns. Such separated CCR supply 2103 may then bypass the macro mill 2186 and be fed directly to the bin hopper 2187. Also, for example, in some embodiments sieving may be performed upstream of macro mill 2186 to separate any CCR supply 2103 that is between approximately 50 and 300 microns into a first grouping and any CCR supply 2103 that is less than approximately 50 microns into a second grouping. The CCR supply 2103 in the first grouping may bypass the macro mill 2186 and be fed into the bin hopper 2187 and the CCR supply 2103 in the second grouping may bypass the macro mill 2186, may bypass the hopper 2187, bypass the micro mill 2189, and be fed into piping downstream of the micro mill 2189. Also, for example, in some embodiments sieving may be performed upstream of macro mill 2186 to separate any CCR supply 2103 that is between approximately 50 and 300 microns into a first grouping, any CCR supply 2103 that is less than approximately 50 microns into a second grouping, any CCR supply 2103 that is between approximately 300 and 1000 microns into a third grouping, and any CCR supply 2103 that is greater than approximately 1000 microns into a fourth grouping. The CCR supply 2103 in the first grouping may bypass the macro mill 2186 and be fed into the bin hopper 2187; the CCR supply in the second grouping may bypass the macro mill 2186, may bypass the hopper 2187, bypass the micro mill 2189, and be fed into piping downstream of the micro mill 2189; the CCR supply 2103 in the third grouping may be fed to the macro mill 2186; and the CCR supply 2103 in the fourth grouping may be fed to the CCR stockpile/impoundment 2102.

Also, for example, in some embodiments sieving may additionally or alternatively be performed downstream of bin hopper 2187 but upstream of micro mill 2189 to separate any CCR supply 2103 that is less than approximately 50 microns. Such separated CCR supply 2103 may then bypass the micro mill 2189 and be fed downstream of the micro mill 2189. Also, for example, in some embodiments sieving may be performed upstream of macro mill 2186 to separate any CCR supply 2103 that is less than 50 microns. The CCR supply 2103 may bypass the macro mill 2186, may bypass the hopper 2187, and be fed directly downstream of the micro mill 2189.

In some embodiments it may be desirable to minimize or omit any milling of the CCR supply 2103. For example, in some embodiments the CCR supply 2103 may not be milled or sorted prior to being fed to the particle reactors 2110A-C. Also, for example, in some embodiments the CCR supply 2103 may be sorted and only CCR of one or more size ranges fed to the particle reactors 2110A-C. For example, the CCR supply 2103 may be sieved to sort and deliver CCR that is less than approximately 100 microns to particle reactors 2110A-C without milling, and anything that is greater than approximately 100 microns may be fed to the CCR stockpile/impoundment 2102.

It is understood that the sizes of CCR supply 2103 recited with respect to the milling and the sorting of CCR supply 2103 are provided as examples only to provide explanation of this optional aspect of the treatment system 2100. One of ordinary skill in the art, having had the benefit of the present disclosure, will recognize and appreciate that in embodiments that implement sieving or otherwise sorting the CCR supply 2103, it may be desirable to sort out one or more CCR groupings of different sizes than those delineated herein. Particular sizes may depend on, for example, one or more of the source of the CCR supply 2103, the chemical characteristics of the CCR supply 2103, the characteristics of the aqueous stream 2101, mills that are present (if any), reaction parameters, efficiency, and/or user preference.

Referring again to FIGS. 18-20, the micro mill 2189 feeds into piping that directs the CCR slurry supply 2103 to one or more of CCR intakes 2114A-C of particle reactors 2110A-C. A motor is illustrated coupled to a valve upstream of each of the CCR intakes 2114A-C and may be selectively actuated to open or close the valve and only feed the CCR slurry supply 2103 to selected one or more of the particle reactors 2110A-C. For example, only a single of the particle reactors 2110A-C may be fed with CCR slurry supply 2103 at one time in some embodiments. The motor may be controlled via a switch in electrical communication with a controller in some embodiments.

In some embodiments the particle reactors 2110A-C may be a reactor vessel, may have approximately a twelve thousand gallon capacity, and/or an approximately 30° cone outlet. The illustrated particle reactors 2110A-C include a motor driving an upper mixer and a lower mixer that help mix the aqueous stream 2101 and the CCR supply 2103 within the particle reactors 2110A-C. The particle reactors 2110A-C also include circum-neutralized slurry outputs 2116A-C at a bottom cone outlet thereof. The circum-neutralized slurry outputs 2116A-C provide for evacuation of the particle reactors 2110A-C and any circum-neutralized slurry that may be within the particle reactors 2110A-C.

Each of the particle reactors 2110A-C may include a high tank level sensor and/or a low tank level sensor. One or more valves may be actuated to alter the flow of the aqueous stream 2101 and/or the CCR supply 2103 into and/or out of the particle reactors 2110A-C based on output from one or more of such sensors. For example, in some embodiments the aqueous stream 2101 and/or the CCR supply 2103 may be fed to an individual of the particle reactors 2110A-C until the high tank level sensor indicates a high tank level. In some embodiments a desired quantity of the aqueous stream 2101 may first be fed into one of the particle reactors 2110A-D and then a desired quantity of the CCR supply 2103 may thereafter be fed into that particle reactor 2110A-D. Each of the particle reactors 2110A-C may also include one or more pressure sensors and/or temperature sensors. For example, as illustrated, each of the particle reactors 2110A-C may include a pressure and temperature sensor pair toward the top of the reactor vessel and another pressure and temperature sensor pair toward the bottom of the reactor vessel. Such sensors may be utilized to monitor and/or analyze the reactions within the particle reactors 2110A-C. For example, temperature change may be monitored to determine when a reaction is complete. Also, for example, temperature change may additionally or alternatively be monitored to determine when a reaction is nearing an unsafe condition. One of ordinary skill in the art, having had the benefit of the present disclosure, will recognize and appreciate that the temperature sensor, other sensor, other devices, and/or user input may be alternatively or additionally utilized to monitor and/or analyze the reaction. For example, various alternative methods and/or apparatus for monitoring and analyzing the reaction within a particle reactor are discussed herein and may optionally be utilized.

Each of the particle reactors 2110A-C is also optionally selectively fed with one or more additives to facilitate the reaction between a quantity of CCR supply 2103 and a quantity of the aqueous stream 2101. The additives may be stored in additive tanks 2111A-C and fed to respective of the particle reactors 2110A-C via metering pumps 2113A-C. The stored additives may include, for example, reagent(s) and/or pH additives and may be selectively added, intermittently added, periodically added, and/or continuously added. For example, in some embodiments reagents may be periodically added dependent on one or more characteristics of the CCR supply 2103 and/or the aqueous stream 2101. In some embodiments the additive tanks 2111A-C may be approximately five hundred to one thousand gallons each. In some alternative embodiments one or more tanks may feed multiple particle reactors 2110A-C. In some embodiments the metering pumps 2113 may be chemical metering pumps Model DME 375-10, available from Grudfos Pumps Corporation of Olathe, Kans.

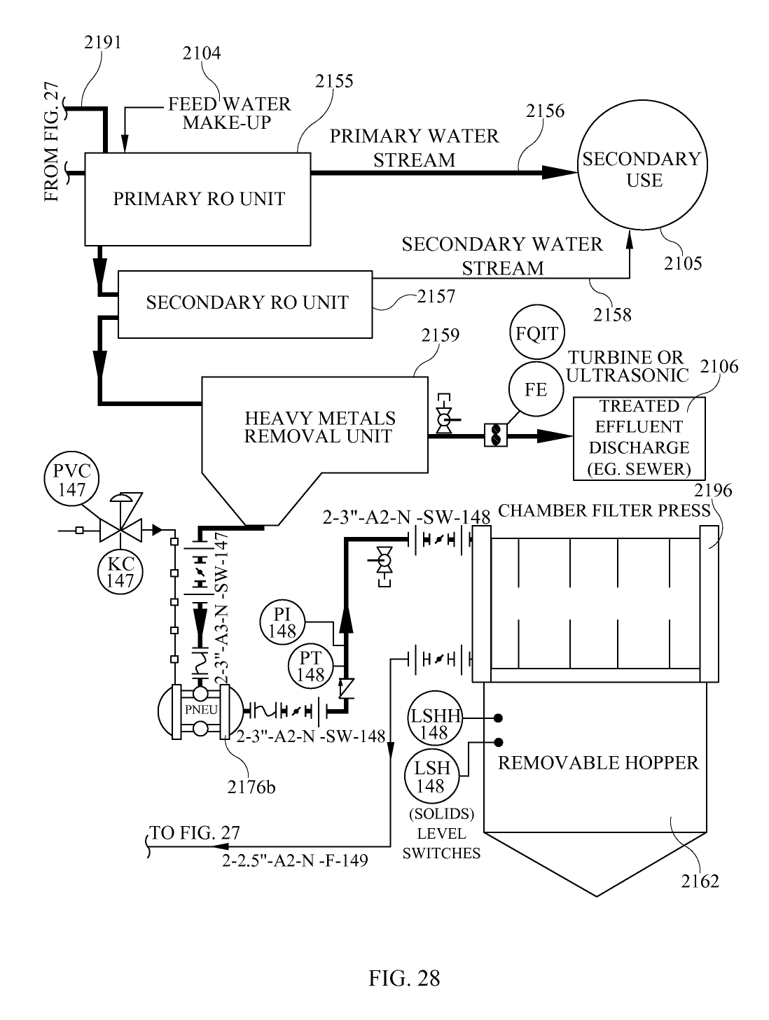

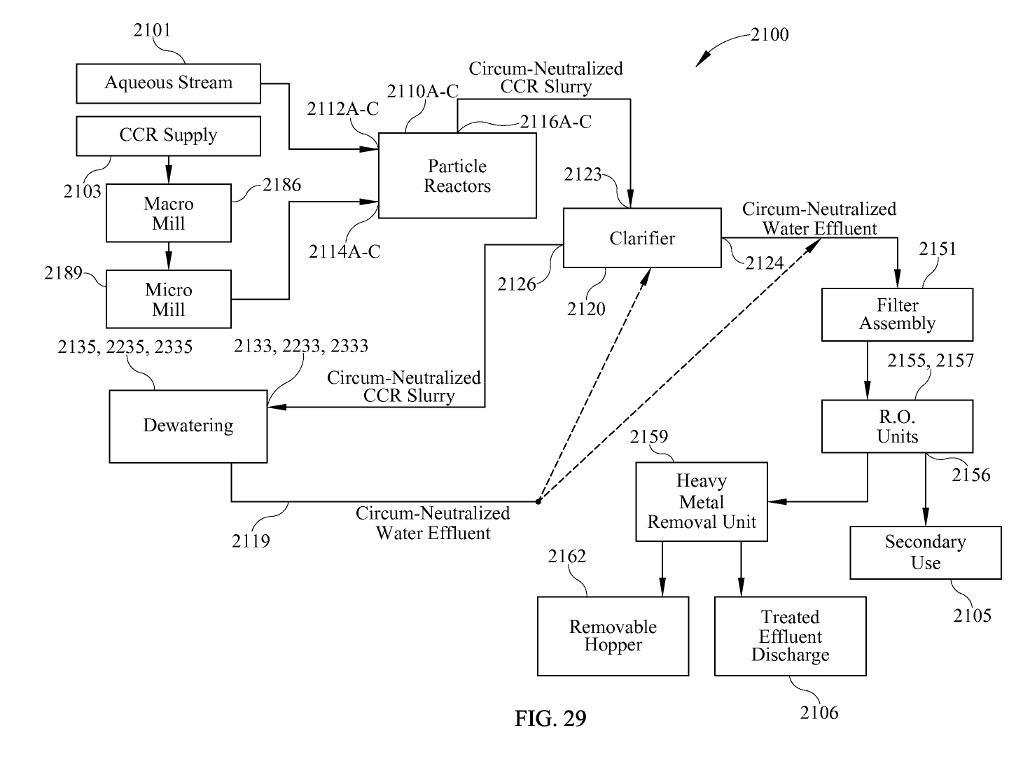

Reaction of a CCR supply 2103 and an aqueous stream 2101 may reduce the oxidation reduction potential (ORP) of the resulting circum-neutralized CCR slurry and circum-neutralized water effluent compared to the incoming aqueous stream 2101 and/or CCR supply 2103. For example, in some embodiments an acidic aqueous stream 2101 prior to reaction may have an ORP of over +400 mV and after reaction the circum-neutralized water effluent may have an ORP of between approximately 0 and +400 mV. In some versions of those embodiments the circum-neutralized water effluent may have an after-reaction ORP of between approximately +25 and +300 mV. One of ordinary skill in the art, having had the benefit of the present disclosure, will recognized and appreciate that other ORP reductions may be achieved as desired based on, for example, characteristics of the aqueous stream 2101, characteristics of the CCR supply 2103, reaction time, the presence of any additives, and/or reaction temperature. Reduced ORP levels may minimize damage to downstream metal components, may minimize disruption in any heavy metals precipitation chemistry, and/or provide for compliance with one or more permits (e.g., NPDES) and/or tests (e.g., TCLP). Also, reaction of a CCR supply 2103 and an aqueous stream 2101 may reduce the metals content of the resulting circum-neutralized CCR cake. Many metals from the CCR supply 2103 may be pulled into the circum-neutralized water effluent that is extracted from the CCR slurry produced by the reaction. Such metals may optionally be captured downstream in the treatment system 2100. For example, the filter assembly 2151 (FIG. 26) may capture precipitated metals and other suspended solids. Also, for example, dissolved phase metals may be captured at reverse osmosis units 2155 and/or 2157, heavy metals removal unit 2159, and/or chamber filter press 2196 and removable hopper 2162 (FIG. 28). In some embodiments removal of metals from the CCR supply 2103 during the reaction may improve TCLP characteristics of the resulting CCR slurry and/or CCR cake that remains after some of the circum-neutralized water effluent is extracted therefrom.

The individual particle reactors 2110A-C may output sufficiently circum-neutralized CCR slurry through respective circum-neutralized slurry outputs 2116A-C. As described in detail herein, each of the particle reactors 2110A-C may retain the quantity of aqueous stream 2101 and the quantity of CCR supply 2103 for an amount of time that is sufficient to enable the two to react such that a pH level of the CCR slurry within a sufficient range of pH levels is obtained. In some embodiments the sufficient range of pH levels may be from approximately 5 to 10. In some versions of those embodiments the sufficient range of pH levels is from approximately 6 to 8. In some embodiments the sufficient range of pH levels may be based on obtaining compliance with one or more permits (e.g., NPDE) and/or tests (e.g., TCLP). In some embodiments the sufficiently circum-neutralized CCR slurry that is output through respective circum-neutralized slurry outputs 2116A-C may have a solids loading percentage that is less than or equal to approximately 80%. In some versions of those embodiments the CCR slurry supply 2103 may have a solids loading percentage of approximately 20% to 80%. In some versions of those embodiments the CCR slurry supply 2103 may have a solids loading percentage of less than or equal to approximately 68% without surfactant. In some embodiments the CCR slurry supply 2103 may have a solids loading percentage of approximately 68% to 80%. In some versions of those embodiments a surfactant may be added to the CCR slurry supply 2103. Pumps 2174a-c may be utilized to assist in the evacuation of the circum-neutralized CCR slurry through respective ones of circum-neutralized slurry outputs 2116A-C and/or the transportation thereof downstream to a circum-neutralized CCR slurry input 2123 of clarifier 2120 (FIG. 21). In some embodiments the pumps 2174a-c may be lined slurry transfer pumps. In some versions of those embodiments the pumps 2174a-c may be Model LCC-R 50-230R, available from GIW Industries of Grovetown, Ga.

Referring now to FIG. 21, the clarifier 2120 includes a circum-neutralized water effluent output 2124 in an upper portion thereof. The clarifier 2120 feeds CCR slurry at a lower portion thereof to a screw conveyor 2122 and a progressing cavity pump 2125 providing a circum-neutralized CCR slurry output 2126. In some embodiments the CCR slurry directed out of the circum-neutralized CCR slurry output 2126 has a pH that is less than or equal to approximately 9. In some versions of those embodiments the CCR slurry directed out of the circum-neutralized CCR slurry output 2126 has a pH from approximately 7 to 9. In some embodiments the circum-neutralized water effluent directed out of the circum-neutralized water effluent output 2124 has an ORP from approximately 0 to +400 mV. In some versions of those embodiments the circum-neutralized water effluent may have an ORP from approximately +25 to +300 mV. In other embodiments the screw conveyor 2122 and/or the progressing cavity pump 2125 may be omitted or replaced with other CCR slurry transfer equipment. In some embodiments the progressing cavity pump may be a Model 4J115G3-CDQ-AAA available from Moyno, Inc. of Springfield, Ohio. In some embodiments the clarifier 2120 may be an inclined plate clarifier. In some versions of those embodiments the clarifier 2120 may be an inclined plate clarifier Model HQI CLA-800LP available from Hydro Quip, Inc. of Seekonk, Mass. In some embodiments the clarifier 2120 may additionally or alternatively include one or more of, for example, a settling tank, a gravity precipitator, a centrifuge, and/or a mechanical screening to facilitate the separation of solids and liquids.

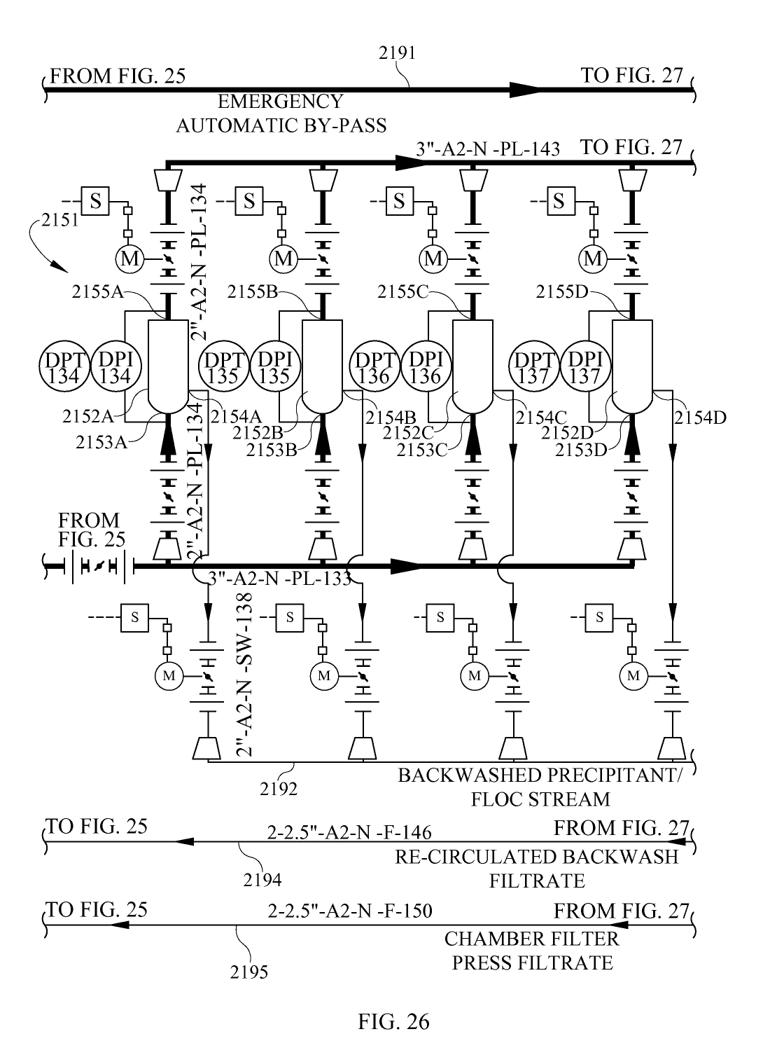

With continuing reference to FIG. 21 and additional reference to FIG. 25, the circum-neutralized water effluent output 2124 directs circum-neutralized water effluent downstream to a batch tank 2192. In some embodiments a pump may be utilized to feed circum-neutralized water effluent from clarifier 2120 to batch tank 2192. In other embodiments the circum-neutralized water effluent from clarifier 2120 may be gravity fed from clarifier 2120 to batch tank 2192. For example, in some versions of those embodiments circum-neutralized water effluent from clarifier 2120 may be gravity fed along piping from clarifier 2120 to batch tank 2192 having an approximately seven degree slope. In some embodiments the circum-neutralized water effluent directed out of the circum-neutralized water effluent output 2124 has a pH from approximately 5 to 10. In some versions of those embodiments the circum-neutralized water effluent directed out of the circum-neutralized water effluent output 2124 has a pH from approximately 6 to 8. In some embodiments the circum-neutralized water effluent directed out of the circum-neutralized water effluent output 2124 has an ORP from approximately 0 to +400 mV. In some versions of those embodiments the circum-neutralized water effluent may have an ORP from approximately +25 to +300 mV. In some embodiments the batch tank 2192 may have a dished bottom and/or have a capacity of approximately 5,000 gallons. The batch tank 2192 may include a high tank level sensor and/or a low tank level sensor. One or more valves may be actuated to alter the flow of the aqueous stream 2101 into and/or out of the batch tank 2192 based on output from one or more of such sensors. For example, in some embodiments if the sensors indicate a high tank, the flow out of the batch tank 2192 may be increased and/or the flow into the batch tank 2192 may be decreased. Also, for example, in some embodiments if the sensors indicate a high tank, at least portions of the circum-neutralized water effluent may be diverted around the batch tank 2192 to a reverse osmosis unit 2155 (FIG. 28) via emergency bypass piping 2191 prior to reaching the batch tank 2192.

The batch tank 2192 may also include a tank level sensor that provides an indication of the current level of cirum-neutralized water effluent in the batch tank 2192. A variable frequency drive 2193 driving a pump 2175d may be driven at a speed that is based on the level of cirum-neutralized water effluent that is in the batch tank 2192. For example, the variable frequency drive 2193 may drive the pump 2175d at a first speed when the level of the batch tank 2192 is indicated to be below a certain value and drive the pump 2175d at a greater second speed when the level of the batch tank 2192 is indicated to be above that certain value. The variable frequency drive 2193 may drive the pump 2175d at more than two speeds in some embodiments and may be continuously variable or may optionally drive the pump 2175d at a plurality of discrete speeds. A backup pump 2175db and/or a backup variable frequency drive 2193b may optionally be provided for redundancy. In some embodiments one or more of the pumps 2175a-db may be centrifugal transfer pumps, Model CRN45-1, available from Gundfos Pumps Corporation of Olathe, Kans.

Turning now to FIGS. 26-28, the pump 2175d feeds a filter assembly 2151 having a plurality of filter housings 2152A-D arranged in a parallel configuration with one another. Each of the illustrated filter housings 2152A-D has a filter input 2153A-D, a filter output 2155A-D, and a filter backwash output 2154A-D. The filter outputs 2155A-D feed the reverse osmosis unit 2155. The filter backwash outputs 2154A-D may be utilized to clean respective filter housings 2152A-D. For example, when a predetermined differential pressure is present across one or more of the filter housings 2152A-D, an inlet valve thereof may be closed and a backwash valve thereof opened, thereby causing a reverse flow of liquid through the filter and backwashing of accumulated debris through a respective of filter backwash outputs 2154A-D. Accumulated debris on the filters may include, for example, suspended solids and/or precipitated metals (e.g., metals pulled from the CCR supply 2103 during the reaction in particle reactor 2110). The filter backwash outputs 2154A-D are fed to filter backwash piping 2192 that in turn feeds a bin hopper 2193. In some embodiments the filter assembly 2151 may include one or more of System 2000, 5-Pod filters available from Zero Gravity Filters, Inc. of Brighton, Mich.

The bin hopper 2193 may include a filter membrane for sludge collection. In some embodiments the bin hopper 2193 may be self-dumping to facilitate removal of collected sludge. The collected sludge may optionally be dewatered and/or disposed of utilizing one or more of the methods and/or apparatus described herein in some embodiments. In other embodiments the collected sludge may be disposed of in another manner (e.g., in barrels or other container due to a potentially high metals content). The bin hopper 2193 draws off liquid that is recirculated back to the filter assembly 2151 via pump 2176a and recirculated backwash filtrate piping 2194. In some embodiments the bin hopper 2193 may be a self-dumping hopper. In some versions of those embodiments the bin hopper 2193 may be a self-dumping hopper container filter available from Flo Trend Systems, Inc. of Houston, Tex.

The circum-neutralized water effluent that is fed to the reverse osmosis unit 2155 (either via bypass piping 2191 or via filter assembly 2151) is either fed to secondary reverse osmosis unit 2157 or recirculated via piping 2156 for one or more secondary uses 2105. In some embodiments the secondary uses 2105 may include utilization of the water in one or more aspect of the treatment system 2100 and/or other upstream process(es). For example, in some embodiments the remediated circum-neutralized water effluent may be fed back into the scrubber, venturi scrubber, and/or other pollution abatement system that may produce the aqueous stream 2101, for use therein. Also, for example, in some embodiments the remediated circum-neutralized water effluent may be fed directly upstream of the particle reactors 2110A-C. In some embodiments the remediated circum-neutralized water effluent fed for secondary uses 2105 may have characteristics that enable it to obtain NPDES permitting. In some embodiments the remediated circum-neutralized water effluent fed for secondary uses 2105 may have a pH from approximately 5 to 10. In some versions of those embodiments the remediated circum-neutralized water effluent fed for secondary uses 2105 may have a pH from approximately 6 to 8. In some embodiments the remediated circum-neutralized water effluent fed for secondary uses 2105 may have an ORP from approximately 0 to +400 mV. In some versions of those embodiments the remediated circum-neutralized water effluent fed for secondary uses 2105 may have an ORP from approximately +25 to +300 mV. In some embodiments approximately 75% of the circum-neutralized water effluent that is fed to the reverse osmosis unit 2155 and output by the reverse osmosis unit 2155 is fed to the secondary use 2105 and approximately 25% is fed to the secondary reverse osmosis unit 2157. In alternative embodiments the remediated circum-neutralized water effluent may additionally or alternatively be discharged to a sewer, holding pond, or elsewhere.

Reject effluent (e.g., effluent saturated with one or more heavy metals and/or other solids) is fed from primary reverse osmosis unit 2155 to secondary reverse osmosis unit 2157. A portion of the effluent that is fed to the secondary reverse osmosis unit 2157 is recirculated for the one or more secondary uses 2105. In some embodiments the remediated circum-neutralized water effluent fed for secondary uses 2105 may have a pH from approximately 5 to approximately 10. In some versions of those embodiments the remediated circum-neutralized water effluent fed for secondary uses 2105 may have a pH from 6 to 8. In some embodiments the remediated circum-neutralized water effluent fed to one or more secondary uses 2105 may have an ORP from approximately 0 to +400 mV. In some versions of those embodiments the remediated circum-neutralized water effluent fed for secondary uses 2105 may have an ORP from approximately +25 to +300 mV. Another portion of the effluent that is fed to the secondary reverse osmosis unit 2157 is fed to a heavy metals removal unit 2159. In some embodiments approximately 50% of the effluent that is fed to the reverse osmosis unit 2157 is fed to the secondary use 2105 and approximately 50% is fed to the secondary reverse osmosis unit 2155. In some embodiments approximately 75% of the circum-neutralized water effluent that is fed to the reverse osmosis unit 2155 and output by the reverse osmosis unit 2155 is fed to the secondary use 2105 and approximately 50% of the effluent that is fed to the secondary reverse osmosis unit 2157 is fed to the secondary use 2105. Accordingly, in those embodiments, approximately 87.5% of the circum-neutralized water effluent that is fed to the primary reverse osmosis unit 2155 is eventually fed to the secondary use 2105. In some embodiments approximately 60% to 67% of the incoming aqueous stream 2101 may end up being recirculated to the secondary use 2105.

Feed water make-up 2104 may optionally be supplied to reverse osmosis unit 2155 or elsewhere to assist in the reverse osmosis process and/or to provide sufficient effluent flow to the downstream secondary use 2105. Feed water make-up 2104 may include effluent from another source such as, for example, a municipal water source. The amount of feed water make-up 2104 supplied may be based on one or more factors such as, for example, the amount of incoming circum-neutralized water effluent provided to the reverse osmosis unit 2155, the characteristics of incoming circum-neutralized water effluent provided to the reverse osmosis unit 2155, the efficiency of reverse osmosis unit 2155 and/or secondary reverse osmosis unit 2157, and/or the demands of secondary use 2105. In some embodiments the reverse osmosis unit 2155 and/or secondary reverse osmosis unit 2157 may be a Model G3 Series available from Culligan International Company of Rosemont, Ill. In other embodiments alternative membrane technologies may optionally be utilized in addition to or as an alternative to reverse osmosis. For example, in some embodiments nano filtration and/or ultra pure water filtration may be utilized.

In some embodiments approximately 50% of the circum-neutralized water effluent that is fed to the secondary reverse osmosis unit 2157 is fed to the heavy metals removal unit 2159. In some versions of those embodiments the approximately 50% of the circum-neutralized water effluent that is fed to the secondary reverse osmosis unit 2157 and then fed to the heavy metals removal unit 2159 represents approximately 12.5% of the circum-neutralized water effluent to the primary reverse osmosis unit 2155. Clarified effluent from the heavy metals removal unit 2159 is fed to a treated effluent discharge 2106 such as, for example, a sewer. In alternative embodiments the clarified effluent may additionally or alternatively be fed to the secondary use 2105. In some embodiments clarified effluent from the heavy metals removal unit 2159 may have a pH from approximately 6 to approximately 9. In some versions of those embodiments clarified effluent from the heavy metals removal unit 2159 may have a pH from approximately 7 to 9. In some embodiments the heavy metals removal unit 2159 may include a Lamella LGS unit available from Parkson Corporation of Fort Lauderdale, Fla. Collected heavy metals sludge from the heavy metals removal unit 2159 is fed to a chamber filter press 2196 via a pneumatic pump 2176b.

The chamber filter press 2196 dewaters the received heavy metals sludge. Effluent from the chamber filter press 2196 is recirculated back to filter assembly 2151 via pump 2176c and recirculated chamber filtrate piping 2195. In some embodiments pneumatic pumps 2176a-c may be EM Series double diaphragm pumps available from Versa-Matic of Mansfield, Ohio. The heavy metals dry cake from the chamber filter press 2196 is fed into a removable hopper 2162 for proper disposal. The removable hopper 2162 may include one or more sensors for indicating when the hopper is in need of dumping or removal. In some embodiments the removable hopper 2162 may be a cake dumpster available from Parkson Corporation of Fort Lauderdale, Florida. Other presses and/or other dewatering structure may be utilized in addition to or as an alternative to filter press 2196 in alternative embodiments.

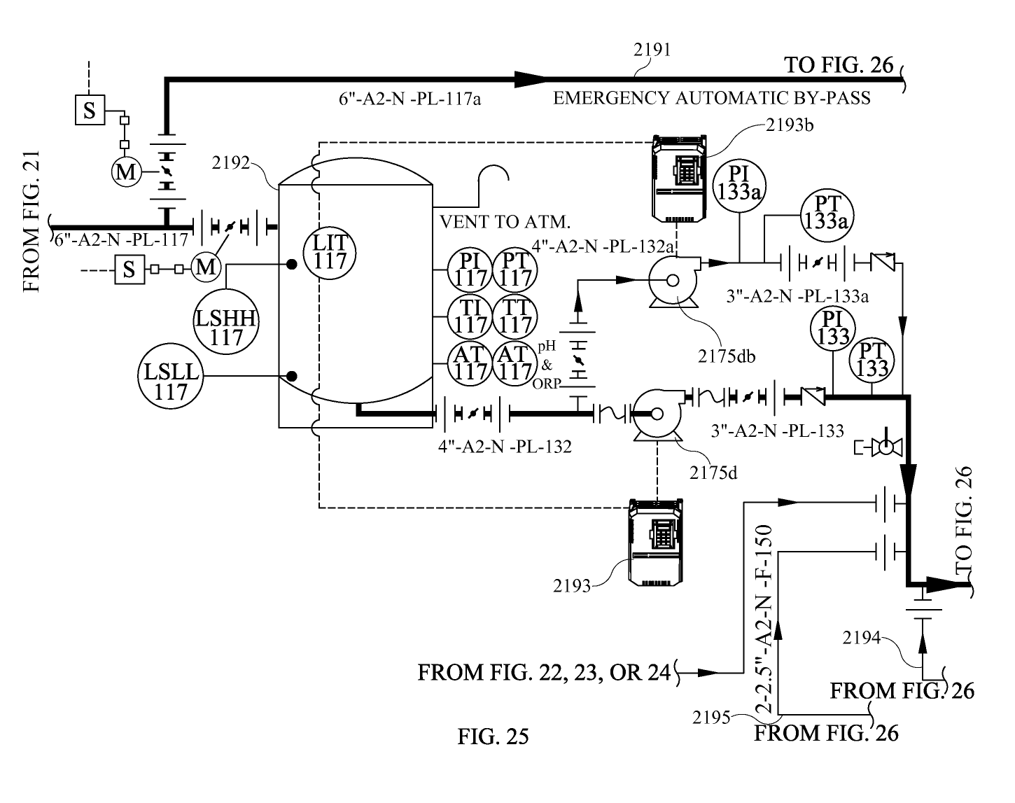

Referring now to FIGS. 22-24, three dewatering structures are illustrated that may be fed by the circum-neutralized CCR slurry output 2126. FIG. 22 illustrates a dewatering structure utilizing a dewatering tube 2135, FIG. 23 illustrates a dewatering structure utilizing a belt filter press 2235, and FIG. 24 illustrates a dewatering structure utilizing a horizontal vacuum filter press 2335. One or more of the dewatering structures of FIGS. 22-24 may be utilized in combination with the treatment system 2100. Also, in other embodiments other dewatering structures may additionally or alternatively be utilized.

The dewatering tube 2135 includes a slurry input 2133 that is fed by the circum-neutralized CCR slurry output 2126. One or more upstream valves may be provided to alter the flow into the dewatering tube 2135. In many embodiments multiple dewatering tubes 2135 may be provided and circum-neutralized CCR slurry output 2126 selectively fed thereto. The dewatering tube 2135 may be made from heavy duty permeable fabric/membrane that traps solids and allows water to escape. In some embodiments the dewatering tube may be a GEOTUBE available from TenCate Industrial Fabrics North America of Pendergrass, Ga. The dewatering tube 2135 is placed atop a grating 2139 in a concrete berm 2138. The grating 2139 enables circum-neutralized water effluent that escapes from the dewatering tube 2135 to pass therethrough. The circum-neutralized water effluent may be collected, for example, in a retaining well 2136 and optionally directed back to clarifier 2120 and/or immediately downstream of clarifier 2120 via sump pump 2132 and piping 2119. Valves in piping 2119 may be actuated to direct circum-neutralized water effluent from retaining well to either clarifier 2120 or downstream of clarifier 2120 (FIG. 21), optionally dependent on the characteristics of the circum-neutralized water effluent and/or the clarifier 2120. Water effluent from the slurry may also additionally or alternatively be directed downstream of batch tank 2192, but upstream of filter assembly 2151 via output 2336 as illustrated in FIG. 25. Also, depending on the characteristics of the water effluent that escapes from the dewatering tube 2135, in some embodiments the circum-neutralized water effluent that escapes from the dewatering tube 2135 may be directed to a sewer and/or be allowed to discharge into the ground, a pond, or elsewhere instead of being recirculated into the system.

The belt filter press 2235 includes a slurry input 2233 that is fed by the circum-neutralized CCR slurry output 2126. One or more upstream valves may be provided to alter the flow into the belt filter press 2235. In some embodiments multiple belt filter presses 2235 may be provided and circum-neutralized CCR slurry output 2126 selectively fed thereto. Water effluent that is pressed from the slurry is directed back to clarifier 2120 and/or immediately downstream of clarifier 2120 via output 2236 and piping 2119. Valves in piping 2119 may be actuated to direct circum-neutralized water effluent from retaining well to either clarifier 2120 or downstream of clarifier 2120 (FIG. 21), optionally dependent on the characteristics of the circum-neutralized water effluent and/or the clarifier 2120. Water effluent that is pressed from the slurry may also additionally or alternatively be directed downstream of batch tank 2192, but upstream of filter assembly 2151 via output 2236 as illustrated in FIG. 25. Also, depending on the characteristics of the water effluent that is pressed from the slurry, in some embodiments the circum-neutralized water effluent that escapes from the belt filter press 2235 may be directed to a sewer and/or be allowed to discharge into the ground, a pond, or elsewhere instead of being recirculated into the system. Substantially stabilized circum-neutral CCR cake from the belt filter press 2235 is directed to a removable hopper 2245 for proper disposal and/or secondary use. The removable hopper 2245 may include one or more sensors for indicating when the hopper is in need of dumping or removal. In some embodiments the belt filter press 2235 may provide approximately 90% drying of the circum-neuralized CCR slurry output 2126. In some embodiments the removable hopper 2245 may be a cake dumpster available from Parkson Corporation of Fort Lauderdale, Fla.

The horizontal filter press 2335 includes a slurry input 2333 that is fed by the circum-neutralized CCR slurry output 2126. One or more upstream valves may be provided to alter the flow into the horizontal filter press 2335. In some embodiments multiple horizontal filter presses 2335 may be provided and circum-neutralized CCR slurry output 2126 selectively fed thereto. Water effluent that is pressed from the slurry is directed back to clarifier 2120 and/or immediately downstream of clarifier 2120 via output 2336 and piping 2119. Valves in piping 2119 may be actuated to direct circum-neutralized water effluent from retaining well to either clarifier 2120 or downstream of clarifier 2120 (FIG. 21), optionally dependent on the characteristics of the circum-neutralized water effluent and/or the clarifier 2120. Water effluent that is pressed from the slurry may also additionally or alternatively be directed downstream of batch tank 2192, but upstream of filter assembly 2151 via output 2336 as illustrated in FIG. 25. Also, depending on the characteristics of the water effluent that is pressed from the slurry, in some embodiments the circum-neutralized water effluent that escapes from the horizontal filter press 2335 may directed to a sewer and/or be allowed to discharge into the ground, a pond, or elsewhere instead of being recirculated into the system. Substantially stabilized circum-neutral CCR cake from the horizontal filter press 2335 is directed to a removable hopper 2345 for proper disposal and/or secondary use. The removable hopper 2345 may include one or more sensors for indicating when the hopper is in need of dumping or removal. In some embodiments the horizontal filter press 2335 may provide approximately 95% drying of the circum-neuralized CCR slurry output 2126. In some embodiments the removable hopper 2345 may be a cake dumpster available from Parkson Corporation of Fort Lauderdale, Fla.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of treating at least one of an acidic waste stream and coal combustion residue, comprising:
feeding an acidic waste stream into a reactor vessel, said acidic waste stream having an acidic waste stream pH from 1 to 4.75;
feeding a coal combustion residue slurry into said reactor vessel, said coal combustion residue slurry having a coal combustion residue slurry pH from 9 to 12 and a coal combustion residue slurry solids loading percentage less than 81%;
allowing said acidic waste stream and said coal combustion residue slurry to react in said reactor vessel and form a circum-neutral coal combustion residue slurry, said circum-neutral coal combustion residue slurry having a circum-neutral coal combustion residue slurry pH from five to ten and a circum-neutral coal combustion residue slurry solids loading percentage less than 81%;
separating a circum-neutral aqueous stream from said circum-neutral coal combustion residue slurry and feeding remaining said circum-neutral coal combustion residue slurry to at least one dewatering structure, said circum-neutral aqueous stream having a circum-neutral aqueous stream pH from 5 to 10;
substantially maintaining said circum-neutral aqueous stream pH while feeding said cirum-neutral aqueous stream through at least one filter unit.

2. The method of claim 1, further comprising feeding, to at least one heavy metals removal unit, a filter unit reject aqueous stream of said circum-neutral aqueous stream fed to said at least one filter unit.

3. The method of claim 2, further comprising feeding a treated aqueous stream of said circum-neutral aqueous stream fed to said at least one filter unit to at least one secondary use, wherein said treated aqueous stream includes a majority of said circum-neutral aqueous stream.

4. The method of claim 3, wherein said treated aqueous stream fed to said at least one secondary use includes at least approximately 75% of said circum-neutral aqueous stream fed to said at least one filter unit.

5. The method of claim 4, wherein said treated aqueous stream fed to said at least one secondary use includes at least approximately 85% of said circum-neutral aqueous stream fed to said at least one filter unit.

6. The method of claim 5, wherein said at least one filter unit includes at least a first membrane filtration unit having a first reject output and a second membrane filtration unit receiving said first reject output.

7. The method of claim 1, further comprising feeding a treated aqueous stream of said circum-neutral aqueous stream fed to said at least one filter unit to at least one secondary use, wherein said secondary use is a process that creates said acidic waste stream.

8. The method of claim 7, wherein said treated aqueous stream fed to said at least one secondary use includes at least sixty percent of said acidic waste stream.

9. The method of claim 7, wherein said process includes utilization of said treated aqueous stream to remove oxides of sulfur from flue gas emanating from a coal combustion process.

10. The method of claim 8, wherein said coal combustion residue slurry originates from said coal combustion process.

11. The method of claim 9, wherein said coal combustion residue slurry originates from a pumped output from said coal combustion process.

12. The method of claim 9, further comprising feeding a filter unit reject aqueous stream of said circum-neutral aqueous stream fed to said at least one filter unit to at least one heavy metals removal unit, wherein said filter unit reject aqueous stream is less than approximately 25% of said circum-neutral aqueous stream fed to said at least filter unit.

13. The method of claim 12, wherein said filter unit reject aqueous stream is less than approximately 13% of said circum-neutral aqueous stream fed to said at least one filter unit.

15. A method of treating at least one of an acidic waste stream and coal combustion residue, comprising:
feeding an acidic waste stream into a reactor vessel, said acidic waste stream having an acidic waste stream pH from 1 to 4.75;
feeding a coal combustion residue into said reactor vessel, said coal combustion residue having a coal combustion residue pH from 10 to 12;
allowing said acidic waste stream and said coal combustion residue to react in said reactor vessel and form a circum-neutral coal combustion residue slurry, said circum-neutral coal combustion residue slurry having a circum-neutral coal combustion residue slurry pH from 6 to 9 and a circum-neutral coal combustion residue slurry solids loading percentage of less than 81%;
separating a circum-neutral aqueous stream from said circum-neutral coal combustion residue slurry and feeding remaining said circum-neutral coal combustion residue slurry to at least one dewatering structure, said circum-neutral aqueous stream having a circum-neutral aqueous stream pH from 6 to 9;
maintaining said circum-neutral aqueous stream pH from 6 to 9 while feeding said substantially cirum-neutral aqueous stream through at least one filter unit.

16. The method of claim 15, further comprising feeding a treated aqueous stream of said circum-neutral aqueous stream fed to said at least one filter unit to at least one secondary use, wherein said treated aqueous stream includes a majority of said circum-neutral aqueous stream.

17. The method of claim 16, wherein said treated aqueous stream fed to said at least one secondary use includes at least 70% of said circum-neutral aqueous stream fed to said at least one filter unit.

18. The method of claim 17, wherein said treated aqueous stream fed to said at least one secondary use includes at least 87.5% of said circum-neutral aqueous stream fed to said at least filter unit.

19. The method of claim 15, further comprising feeding, to at least one heavy metals removal unit, a filter unit reject output of said circum-neutral aqueous stream fed to said at least one filter unit, wherein said filter unit reject output is less than approximately 25% of said circum-neutral aqueous stream fed to said at least one filter unit.

20. The method of claim 15, wherein said coal combustion residue is mixed with water to obtain a CCR slurry solids loading percentage of sixty to eighty percent prior to feeding said coal combustion residue into said reactor vessel.

21. The method of claim 15, wherein said acidic waste stream pH is from 1 to 3.

22. The method of claim 21, wherein said coal combustion residue pH is from 11 to 12.

23. A method of treating at least one of an aqueous stream and a coal combustion residue, comprising:
feeding an aqueous stream into a reactor vessel, said aqueous stream having an aqueous stream oxidation reduction potential level and one of an acidic pH and an alkaline pH;
feeding a coal combustion residue slurry into said reactor vessel, said coal combustion residue slurry having the other of said acidic pH and said alkaline pH and having a coal combustion residue slurry solids loading percentage of less than 81%;
allowing said aqueous stream and said coal combustion residue slurry to react in said reactor vessel and form a circum-neutral coal combustion residue slurry, said circum-neutral coal combustion residue slurry having a circum-neutral coal combustion residue slurry pH from 6 to 9, a circum-neutral coal combustion residue slurry solids loading percentage of less than 81%, and a circum-neutral coal combustion residue oxidation reduction potential level that is from +25 millivolts to +300 millivolts and that is less than said aqueous stream oxidation reduction potential level;
separating a circum-neutral aqueous stream from said circum-neutral coal combustion residue slurry and feeding remaining said circum-neutral coal combustion residue slurry to at least one dewatering structure, said circum-neutral aqueous stream having a circum-neutral aqueous stream pH from 6 to 9 and a circum-neutral aqueous stream oxidation reduction potential level that is from +25 millivolts to +300 millivolts and that is less than said aqueous stream oxidation reduction potential level; and
maintaining said circum-neutral aqueous stream pH from 6 to 9 while feeding said substantially cirum-neutral aqueous stream through at least one filter unit.

24. The method of claim 23, further comprising feeding a treated aqueous stream of said circum-neutral aqueous stream fed to said at least one filter unit to at least one secondary use, wherein said treated aqueous stream includes a majority of said circum-neutral aqueous stream and a majority of said aqueous stream.
